(19) United States
(12) Patent Application Publication
(10) Pub. No.: US 2016/0140095 A1
(43) Pub. Date: May 19, 2016

(54) DEVICE AND METHOD FOR MANAGING REFERENCE INFORMATION FOR PROVIDED CONTENT

(71) Applicant: Samsung Electronics Co., Ltd., Gyeonggi-do (KR)

(72) Inventors: Ji-Hyun PARK, Gyeonggi-do (KR); Myung-Gon HONG, Gyeonggi-do (KR); Sung-Hyuk SHIN, Gyeonggi-do (KR); Chang-Hyun AHN, Gyeonggi-do (KR); Sun-Kee LEE, Gyeonggi-do (KR); Jin-Hong JEONG, Gyeonggi-do (KR)

(73) Assignee: Samsung Electronics Co., Ltd.

(21) Appl. No.: 14/944,882

(22) Filed: Nov. 18, 2015

(30) Foreign Application Priority Data
Nov. 18, 2014 (KR) 10-2014-0161084
Nov. 18, 2015 (KR) 10-2015-0161777

(51) Int. Cl. G06F 17/24; G06F 17/30; G06F 17/22

(52) U.S. Cl. CPC G06F 17/24; G06F 17/2205; G06F 17/30595

(57) ABSTRACT

An electronic device and method for managing reference information for provided content is provided. The electronic device may include a display, a memory configured to store reference information executed in relation to the creation or editing of a content, and a processor configured to output the content through the display and output at least some of the reference information in relation to the content.

### PRIORITY

This application claims priority under 35 U.S.C. §119(a) to Korean Patent Application Serial No. 10-2014-0161084, which was filed in the Korean Intellectual Property Office on Nov. 18, 2014, and Korean Patent Application Serial No. 10-2015-0161777, which was filed in the Korean Intellectual Property Office on Nov. 18, 2015, the entire content of each of which is incorporated herein by reference.

### BACKGROUND

1. Field of Invention

The present disclosure relates generally to an electronic device, and more particularly, to an electronic device and a method for managing reference information for provided content.

2. Description of Related Art

With the development of computing devices and communication technologies, users of electronic devices share content created through the electronic devices with other users. For example, a writer using an electronic device can share content, such as documents, images, or video, created with the electronic device with readers or co-workers. In addition, users of electronic devices can collaborate in creating, editing, and reading content through the electronic devices.

For example, a plurality of electronic devices that can create documents may be connected to a document management server for managing documents created by a plurality of users in collaboration. For example, a first user (e.g., writer) may create a document in a first electronic device connected to a document management server. In this case, the first electronic device may transmit the created document to the document management server. The document management server stores the transmitted document in a database or a storage which is functionally connected to the document management server.

A second user (e.g., reader or coworker) may make a request for reading the document, through a second electronic device connected to the document management server, in order to edit the document. Accordingly, the second electronic device may acquire the document from the document management server and may provide the document to the second user. The second user may edit at least a portion of the document through the second electronic device. The second electronic device may transmit the edited document to the document management server. In this case, the document management server may update the edited document in the memory connected to the document management server.

### SUMMARY

However, while content, such as a document, an image, or a video, created by a writer (e.g., the first user) through an electronic device may be shared with a reader or coworker (e.g., the second user), as well as the writer through the electronic device or another electronic device, other pieces of content (e.g., web pages, e-mail, or documents stored on local disks or servers) used by the writer during the creation of the content (hereinafter, “reference information”) may not be associated with the content. Therefore, if the writer does not intentionally associate the reference information with the content, for example, through annotation, to store the same as a portion of the content, the reader or coworker can read or edit the content created by the writer and cannot identify a list or contents of the related reference information.

Furthermore, it is not possible to identify the information that is referred to in relation to the creation or execution of a certain specific portion of the created content. When a reader wants to know more about a web page or information included therein, which has been accessed in the creation of the content, although not included in the content, the reader has to manually search for the web page or the information by directly asking the writer, or by directly using related records (e.g., a visit history) left in a system, for example, by using a browser used for searching for the web page. Accordingly, there is a need for efficiently managing and providing to a user, reference information associated with content.

The present disclosure has been made to address at least the problems and disadvantages described above, and to provide at least the advantages described below.

Accordingly, an aspect of the present disclosure is to provide content created by a writer to a plurality of readers in various formats (e.g., colors, sizes, or shapes) corresponding to the respective readers.

Accordingly, another aspect of the present disclosure is to allow the plurality of readers, having different user characteristics, such as a degree of interest in or a level of knowledge about a content, to easily acquire information suitable to their own characteristics through the content. For example, a first reader who is an expert and a second reader who is a layman can identify a document created by a writer who is an expert. In this case, the document can be directly provided to the first reader, while another document corresponding to the document which is appropriate for a level of a layman, can be provided to the second reader, in this way, the first and second readers can easily understand information included in the document irrespective of their knowledge levels.

Accordingly, another aspect of the present disclosure is to manually, automatically, or semi-automatically identify, classify, designate, and store reference information, which is used or accessed by a writer while creating or editing content, thereby eliminating an inconvenience created when a user must separately manage the content and the reference information.

Accordingly, another aspect of the present disclosure is to provide content and reference information, which are associated with each other, to a reader, thereby eliminating the inconvenience created when the reader must separately search for the reference information.

Accordingly, another aspect of the present disclosure is to provide content or reference information in various manners based on user information (e.g., a degree of interest or a level of knowledge) of a reader, thereby helping to provide suitable information to the reader.

In accordance with an aspect of the present disclosure, an electronic device is provided. The electronic device may include a display, a memory configured to store reference information executed in relation to the creation or editing of content, and a content management module (e.g., a processor) configured to output the content and output at least some of the reference information in relation to the content.

In accordance with another aspect of the present disclosure, a method in an electronic device is provided. The method may include acquiring first content, identifying second content executed in relation to the creation or editing of the first content, and designating the second content as reference information for the first content.

In accordance with another aspect of the present disclosure, a method in an electronic device is provided. The method may include identifying, by an electronic device, content provided through an external electronic device for the electronic device, determining at least some reference information that is to be provided in relation to the content among reference information that is executed in regard to creating or editing subject content, and transmitting the at least some reference information to the external electronic device.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates a network environment including a plurality of electronic devices, according to an embodiment of the present disclosure;

FIG. 2 is a block diagram of a configuration of an electronic device, according to an embodiment of the present disclosure;

FIG. 3 is a block diagram of a program module of an electronic device, according to an embodiment of the present disclosure;

FIG. 4 illustrates a content service environment using electronic devices, according to an embodiment of the present disclosure;

FIG. 5 is a block diagram of a content management module of an electronic device, according to an embodiment of the present disclosure;

FIG. 6 illustrates an information storage structure, according to an embodiment of the present disclosure;

FIG. 7A illustrates a user interface for providing content, according to an embodiment of the present disclosure;

FIG. 7B illustrates a user interface for providing content, according to an embodiment of the present disclosure;

FIG. 7C illustrates a user interface for providing content, according to an embodiment of the present disclosure;

FIG. 8 illustrates a user interface for providing content, according to an embodiment of the present disclosure;

FIG. 9 illustrates a user interface for providing content, according to an embodiment of the present disclosure;

FIG. 10 is a flowchart illustrating a method for designating reference information in an electronic device, according to an embodiment of the present disclosure;

FIG. 11 is a flowchart illustrating a method for identifying execution content, according to an embodiment of the present disclosure; and

FIG. 12 is a flowchart illustrating a method for providing reference information in an electronic device, according to an embodiment of the present disclosure.

### DETAILED DESCRIPTION OF EMBODIMENTS OF THE PRESENT INVENTION

Hereinafter, various embodiments of the present disclosure will be described with reference to the accompanying drawings. In the following description, specific details such as detailed configuration and components are merely provided to assist the overall understanding of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications/changes, equivalents, and/or alternatives falling within the spirit and the scope of the present disclosure. In describing the drawings, similar reference numerals may be used to designate similar elements.

The terms “have”, “may have”, “include”, and “may include” used herein indicate the presence of disclosed corresponding functions, operations, elements, and the like, and do not limit additional one or more functions, operations, elements, and the like. In addition, it should be understood that the terms “include” and “have” used herein are to indicate the presence of features, numbers, steps, operations, elements, parts, or a combination thereof described in the specifications, and do not preclude the presence or addition of one or more other features, numbers, steps, operations, elements, parts, or a combination thereof.

The terms “A or B”, “at least one of A or/and B” or “one or more of A or/and B” used herein include any and all combinations of words enumerated with it. For example, “A or B”, “at least one of A and B” and “at least one of A or B” mean (1) including A, (2) including B, or (3) including both A and B.

Although terms such as “first” and “second” used herein may modify various elements, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be referred to as a second element without departing from the scope of the present disclosure, and similarly, a second element may be referred to as a first element.

It will be understood that when an element (e.g., first element) is “connected” or “coupled” with/to another element (e.g., second element), the first element may be directly connected or coupled to the second element, or there may be an intervening element (e.g., third element) between the first element and the second element. To the contrary, it will be understood that when an element (e.g., first element) is “directly connected” or “directly coupled” with/to another element (e.g., second element), there is no intervening element (e.g., third element) between the first element and the second element.

The expression “configured to” used herein may be replaced with “suitable for”, “having the capacity to”, “designed to”, “adapted to”, “made to”, or “capable of” according to a situation. The term “configured to”, with respect to hardware, does not necessarily mean “specifically designed to”. Instead, an apparatus “configured to . . . ” may mean that the apparatus is “capable of . . . ” along with other devices or parts. For example, “a processor configured to perform A, B, and C” may be a dedicated processor, e.g., an embedded processor, for performing a corresponding operation, or a generic-purpose processor, e.g., a Central Processing Unit (CPU) or an application processor (AP), capable of performing a corresponding operation by executing one or more software programs stored in a memory device.

The terms as used herein are used merely to describe certain embodiments and are not intended to limit the present disclosure. As used herein, singular forms may include plural forms as well unless the context explicitly indicates otherwise. Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined in various embodiments of the present disclosure.

A module or programming module according to various embodiments of the present disclosure may further include at least one or more constituent elements among the aforementioned constituent elements, or may omit some of them, or may further include additional other constituent elements. Operations performed by a module, programming module, or other constituent elements may be executed in a sequential, parallel, repetitive, or heuristic manner, in addition, some of the operations may be executed in a different order, may be omitted, or other operations may be added.

An electronic device according to various embodiments of the present disclosure may include at least one of a smart phone, a tablet Personal Computer (PC), a mobile phone, a video phone, an e-book reader, a desktop PC, a laptop PC, a netbook computer, a workstation, a server, a personal digital assistant (PDA), a Portable Multimedia Player (PMP), an MP3 player, a mobile medical device, a camera, and a wearable device (e.g., a Head Mounted Device (MID), an electronic glasses, an electronic clothing, an electronic bracelet, an electronic necklace, an electronic appcessory, an electronic tattoo, a smart mirror, or a smart watch).

In other embodiments, an electronic device may be a smart home appliance. For example, such appliances may include at least one of a television (TV), a Digital Versatile Disk (DVD) player, an audio component, a refrigerator, an air conditioner, a vacuum cleaner, an oven, a microwave oven, a washing machine, an air cleaner, a set-top box, a home automation control panel, a security control panel, a TV box (e.g., Samsung HomeSync®, Apple TV®, or Google TV), a game console (e.g., Xbox® PlayStation®), an electronic dictionary, an electronic key, a camcorder, or an electronic frame.

In other embodiments, an electronic device may include at least one of medical equipment (e.g., a mobile medical device (e.g., a blood glucose monitoring device, a heart rate monitor, a blood pressure monitoring device or a temperature meter), a Magnetic Resonance Angiography (MRA) machine, a Magnetic Resonance Imaging (MRI) machine, a Computed Tomography (CT) scanner, or an ultrasound machine), a navigation device, a Global Positioning System (GPS) receiver, an Event Data Recorder (EDR), a Flight Data Recorder (FDR), an in-vehicle infotainment device, electronic equipment for a ship (e.g., ship navigation equipment and/or a gyrocompass), avionics equipment, security equipment, a head unit for a vehicle, an industrial or home robot, an Automatic Teller Machine (ATM) of a financial institution, Point Of Sale (POS) device at a retail store, or an Internet Of Things device (e.g., a Lightbulb, various sensors, an electronic meter, a gas meter, a sprinkler, a tire alarm, a thermostat, a streetlamp, a toaster, a sporting equipment, a hot-water tank, a heater, or a boiler and the like)

In certain embodiments, an electronic device may include at least one of a piece of furniture or a building/structure, an electronic board, an electronic signature receiving device, a projector, and various measuring instruments (e.g., a water meter, an electricity meter, a gas meter, or a wave meter).

An electronic device according to various embodiments of the present disclosure may also include a combination of one or more of the above-mentioned devices.

Further, it will be apparent to those skilled in the art that an electronic device according to various embodiments of the present disclosure is not limited to the above-mentioned devices.

Herein, the term “user” may indicate a person who uses an electronic device or a device (e.g., an artificial intelligence electronic device) that uses the electronic device.

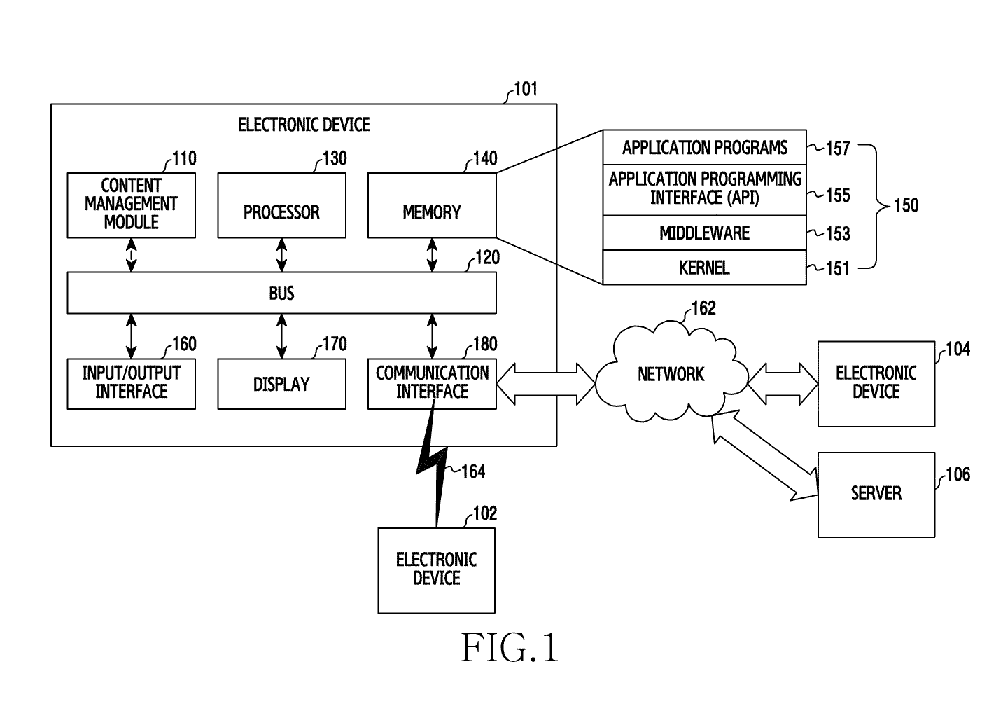

FIG. 1 illustrates a network environment including a plurality of electronic devices, according to an embodiment of the present disclosure.

Referring to FIG. 1, an electronic device 101 is provided. The electronic device 101 may include a content management module 110, a bus 120, a processor 130, a memory 140, an input/output interface 160, a display 170, and a communication interface 180. In some embodiments, at least one of the above elements may be omitted or may further include other elements.

The content management module 110 may provide an environment in which a user (e.g., writer) may directly create or edit content (hereinafter, “subject content”). The content management module 110 may store and provide the created or edited subject content. The content management module 110 may designate (or store) one or more pieces of different content (hereinafter, “execution content”), which are referred to (e.g., used or executed) in the creation or editing of the subject content, as reference information for the subject content.

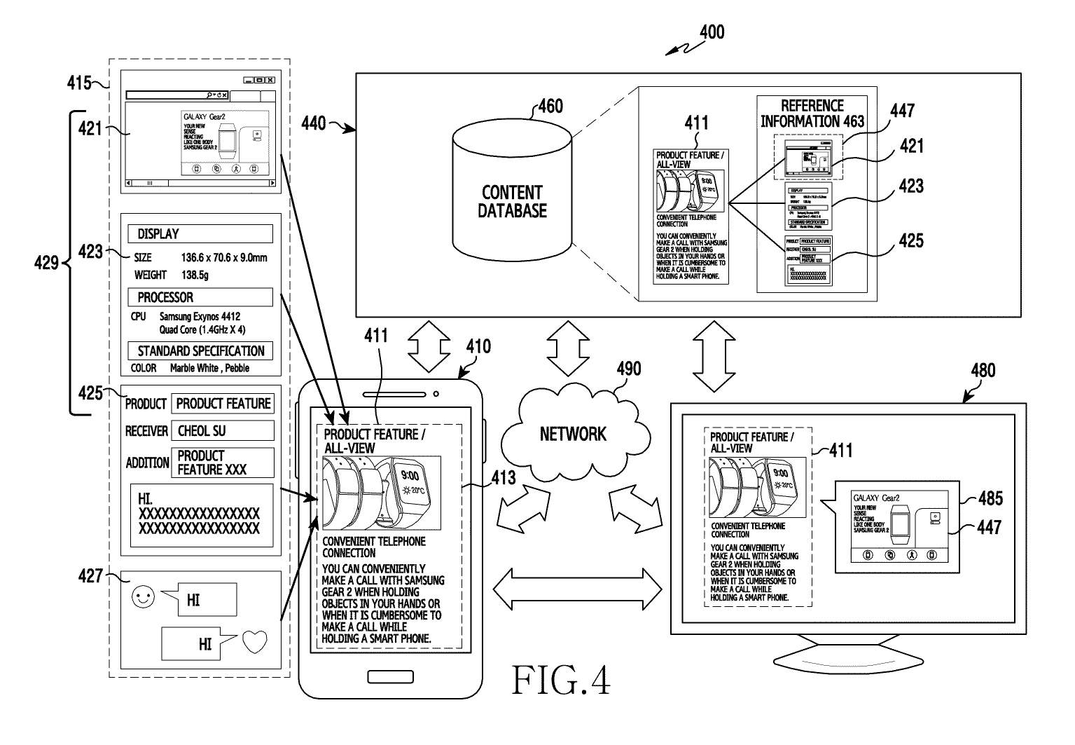

For example, the content management module 110 (e.g., executable by the processor 130) may distinguish first subject content and first execution content corresponding thereto from second subject content and second execution content corresponding thereto to store them. The content management module 110 may provide the subject content and the execution content to the user through an output device (e.g., the display 170 or a display included in a first external electronic device 102 or a second external electronic device 104) functionally connected to the electronic device 101. According to an embodiment, at least a part of the content management module 110 may be included in the processor 130 or the memory 140. Additional information associated with the content management module 110 will be described below in conjunction with FIGS. 4 to 12.

The bus 120 may include a circuit for connecting the content management module 110 and the processor 130 to the communication interface 180 and transferring communication (e.g., control messages and/or data) between the elements.

The processor 130 may include one or more of a Central Processing Unit (CPU), an Application Processor (AP), and a Communication Processor (CP). The processor 130 may carry out operations or data processing relating to control and/or communication of at least one other element of the electronic device 101.

The memory 140 may include a volatile memory and/or a non-volatile memory. The memory 140 may store instructions or data relevant to at least one other element of the electronic device 101. The memory 140 may store software and/or a program 150. The program 150 may include a kernel 151, middleware 153, an Application Programming Interface (API) 155, and/or application programs 157. At least some of the kernel 151, the middleware 153, and the API 155 may be referred to as an Operating System (OS).

The kernel 151 may control or manage system resources (e.g., the bus 120, the processor 130, or the memory 140) used for performing an operation or function implemented by the other programs (e.g., the middleware 153, the API 155, or the application programs 157). Furthermore, the kernel 151 may provide an interface through which the middleware 153, the API 155, or the application programs 157 may access the individual elements of the electronic device 101 to control or manage the system resources.

The middleware 153 may function as an intermediary for allowing the API 155 or the application programs 157 to communicate with the kernel 151 to exchange data.

In addition, the middleware 153 may process one or more task requests received from the application programs 157 according to priorities thereof. For example, the middleware 153 may assign priorities for using the system resources (e.g., the bus 120, the processor 130, the memory 140, etc.) of the electronic device 101, to at least one of the application programs 157. For example, the middleware 153 may perform scheduling or loading balancing on one or more task requests by processing the one or more task requests according to the priorities assigned thereto.

The API 155 is an interface through which the application programs 157 control functions provided from the kernel 151 or the middleware 153, and may include at least one interface or function (e.g., instruction) for file control, window control, image processing, or text control.

The input/output interface 160 may function as an interface that may transfer instructions or data input from a user or another external device to the other element(s) of the electronic device 101. Furthermore, the input/output interface 160 may output the instructions or data received from the other elements of the electronic device 101 to the user or another external device.

The display 170 may include, for example, a Liquid Crystal Display (LCD), a. Light Emitting Diode (LED) display, an Organic Light Emitting Diode (OLED) display, a Micro Electro Mechanical System (MEMS) display, or an electronic paper display. The display 170 may display various types of content (e.g., text, images, videos, icons, or symbols) for the user. The display 170 may include a touch screen and receive, for example, a touch, gesture, proximity, or hovering input using an electronic pen or the user's body part.

The communication interface 180 may set communication between the electronic device 101 and an external device (e.g., the first external electronic device 102, the second external electronic device 104, or a server 106). For example, the communication interface 180 may be connected to a network 162 through wireless or wired communication to communicate with the external device e.g., the second external electronic device 104 or the server 106).

The wireless communication may use at least one of for example, Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), and Global System for Mobile Communications (GSM), as a cellular communication protocol. In addition, the wireless communication may include, for example, short range communication 164. The short-range communication 164 may include at least one of, for example, WiFi, Bluetooth, Near Field Communication (NFC), and Global Positioning System (GPS).

The wired communication may include at least one of, for example, a Universal Serial Bus (USB), a High Definition Multimedia interface (HDMI), Recommended Standard-232 (RS-232), and a Plain Old Telephone Service (POTS).

The network 162 may include at least one of a communication network such as a computer network (e.g., a LAN or a WAN), the Internet, and a telephone network.

At least one of the first external electronic devices 102 and second external electronic device 104 may be the same or a different type of device from the electronic device 101. The server 106 may include a group of one or more servers.

All or some of the operations performed in the electronic device 101 may be performed in another electronic device or a plurality of electronic devices (e.g., the first external electronic device 102 and the second external electronic device 104 or the server 106). When the electronic device 101 has to perform some functions or services automatically or in response to a request, the electronic device 101 may make a request for performing at least some functions relating thereto to the first external electronic device 102, the second external electronic device 104 or the server 106, instead of performing the functions or services by itself or in addition.

In this case, the first external electronic device 102, the second external electronic device 104, or the server 106 may carry out the requested functions or the additional functions and transfer the result to the electronic device 101. The electronic device 101 may process the received result as it is or additionally to provide the requested functions or services. To achieve this, for example, cloud computing, distributed computing, or client-server computing technology may be used.

According to various embodiments of the present disclosure, the content management module 110 may be included the processor 130.

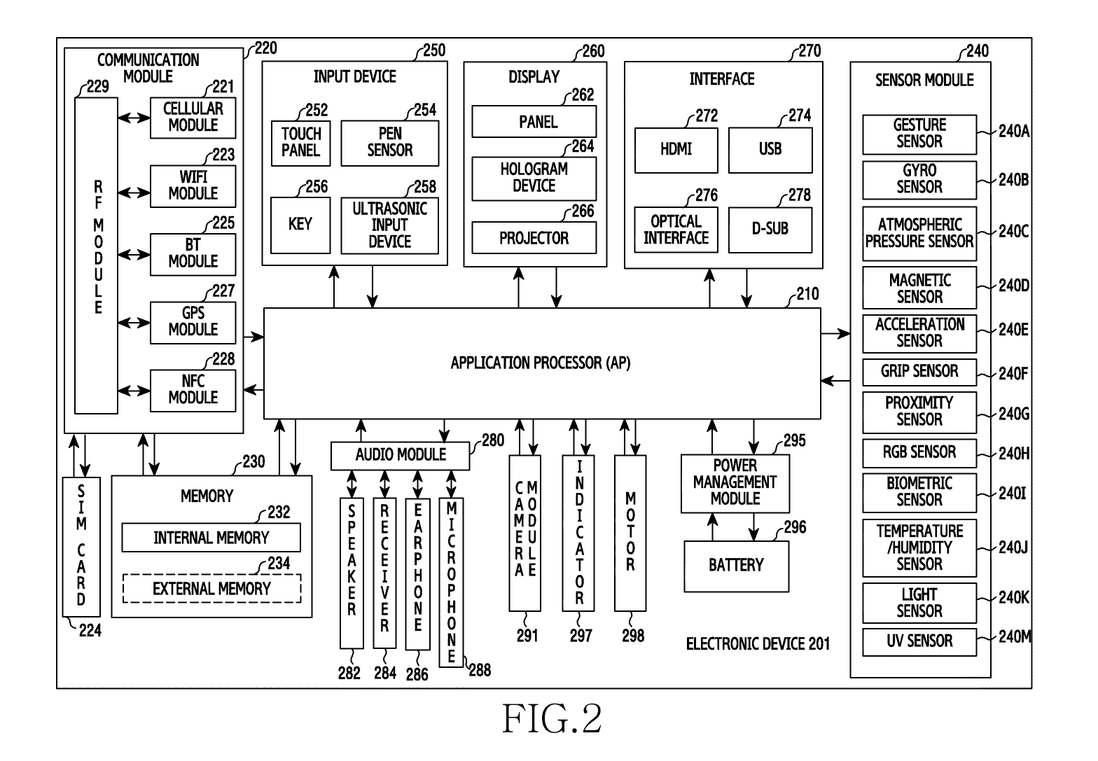

FIG. 2 is a block diagram of a configuration of an electronic device, according to an embodiment of the present disclosure.

Referring to FIG. 2, the electronic device 201 may include all or some of the components of the electronic device 101 illustrated in FIG. 1. The electronic device 201 may include one or more processors (e.g., AP 210), a communication module 220, a Subscriber Identity Module (SIM) card 224, a memory 230, a sensor module 240, an input device 250, a display 260, an interface 270, an audio module 280, a camera module 291, a power management module 295, a battery 296, an indicator 297, and a motor 298.

The processor 210 may drive an OS or an application program to control a plurality of hardware or software components connected to the processor 210 and to perform a variety of data processing and operations. The processor 210 may be implemented in an SoC (System on Chip). The processor 210 may further include a Graphics Processing Unit (GPU) and/or an image signal processor. The processor 210 may include at least some (e.g., a cellular module 221) of the components illustrated in FIG. 2. The processor 210 may load an instruction or data received from at least one of the other components (e.g., a non-volatile memory) to a volatile memory to process the loaded instruction or data, and store a variety of data in the non-volatile memory.

The communication module 220 may be the same as or similar to the communication interface 180 of FIG. 1. The communication module 220 may include the cellular module 221, a Wi-Fi module 223, a Bluetooth module 225, a GPS module 227, a Near Field Communication (NFC) module 228, and a Radio Frequency (RF) module 229.

The cellular module 221 may provide voice calls, video calls, Short Message Services (SMSs), Internet services, etc., through a communication network. The cellular module 221 may perform identification and authentication of the electronic device 201 within a communication network, using a SIM card 224. The cellular module 221 may perform at least some of functions that can be provided by the processor 210. According to an embodiment, the cellular module 221 may include a Communication Processor (CP).

At least one of the Wi-Fi module 223, the Bluetooth module 225, the GPS module 227, and the NFC module 228 may include a processor for processing data transmitted and received through the corresponding module. At least some of the cellular module 221, the Wi-Fi module 223, the Bluetooth module 225, the GPS module 227, and the NFC module 228 may be included within a single Integrated Chip (IC) or an IC package.

The RF module 229 may transmit and receive communication signals (e.g., RF signals). The RF module 229 may include, for example, a transceiver, a Power Amp Module (PAM), a frequency filter, a Low Noise Amplifier (LNA), an antenna, etc. According to another embodiment, at least one of the cellular module 221, the Wi-Fi module 223, the Bluetooth module 225, the GPS module 227, and the NFC module 228 may transmit and receive the RF signals through a separate RF module.

The SIM card 224 may include unique identification information (e.g., Integrated Circuit Card Identifier (ICCID)) or subscriber information (e.g., International Mobile Subscriber Identity (IMSI).

The memory 230 (e.g., the memory 140) may include, for example, an internal memory 232 or an external memory 234.

The internal memory 232 may include, for example, at least one of a volatile memory (e.g., a Dynamic Random Access Memory (DRAM), an Static RAM (SRAM), an Synchronous Dynamic RAM) (SDRAM), etc.) and a non-volatile memory (e.g., a One-Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash, a NOR flash, or the like), a hard drive, or a solid state drive (SSD)).

The external memory 234 may include a flash drive, for example, a Compact Flash (CF), a Secure Digital (SD), a Micro Secure Digital (Micro-SD), a Mini Secure Digital (Mini-SD) card, an extreme Digital (xD), a Multimedia Card (MMC), a memory stick, etc. The external memory 234 may be functionally and/or physically connected to the electronic device 201 through various interfaces.

The sensor module 240 may measure a physical quantity or detect an operation state of the electronic device 201 and thereby convert the measured and detected information into electric signals. The sensor module 240 may include at least one of a gesture sensor 240A, a gyro sensor 24013, an atmospheric pressure sensor 240C, a magnetic sensor 240D, an acceleration sensor 240E, a grip sensor 240F, a proximity sensor 240G, a color sensor 240H (e.g., an Red, Green, and Blue (RGB) sensor), a biometric sensor 240I, a temperature/humidity sensor 240J, a light sensor 240K, and a Ultraviolet (UV) sensor 240M.

Additionally or alternatively, the sensor module 240 may include, for example, an F-nose sensor, an electromyography (EMG) sensor, an electroencephalogram (EEG) sensor, an electrocardiogram (ECG) sensor, an Infrared (IR) sensor, an iris sensor, a force touch sensor, and/or a fingerprint sensor.

The sensor module 240 may further include a control circuit for controlling one or more sensors included therein. In some embodiments, the electronic device 201 may further include a processor that is configured to control the sensor module 240 as a part of the processor 210 or separately from the processor 210, so that the sensor module 240 may be controlled even while the processor 210 is in a sleep state.

The input device 250 may include a touch panel 252, a (digital) pen sensor 254, a key 256, and an ultrasonic input device 258.

The touch panel 252 may use at least one of an electrostatic scheme, a pressure-sensitive scheme, an infrared scheme, and an ultrasonic scheme. In addition, the touch panel 252 may further include a control circuit. The touch panel 252 may further include a tactile layer, and thereby provide a user with a tactile reaction.

The (digital) pen sensor 254 may be a part of the touch panel, or include a separate sheet for recognition.

The key 256 may include, for example, physical buttons, an optical key, or a keypad.

The ultrasonic input device 258 may detect ultrasonic waves generated from an input tool via a microphone 288, and determine data corresponding to the detected ultrasonic waves.

The display 260 (e.g., the display 170) may include a panel 262, a hologram device 264, or a projector 266.

The panel 262 may be implemented in a flexible, transparent, or wearable manner. The panel 262 may be constructed as one module with the touch panel 252.

The hologram device 264 may use an interference of light and may display a stereoscopic image in the air.

The projector 266 may project light to a screen and display an image. The screen may be positioned, for example, inside or outside the electronic device 201.

The display 260 may further include a control circuit for controlling the panel 262, the hologram device 264, or the projector 266.

The interface 270 may include a High-Definition Multimedia Interface (HDMI) 272, a Universal Serial Bus (USB) 274, an optical interface 276, or a D-subminiature (D-sub) 278. The interface 270 may be included in the communication interface 180 illustrated in FIG. 1.

Additionally or alternatively, the interface 270 may include a Mobile High-Definition Link (MHL) interface, an SD card/MMC interface, or an Infrared Data Association (IrDA) standard interface.

The audio module 280 bilaterally may convert sounds and electric signals. At least some components of the audio module 280 may be included in the I/O interface 160 illustrated in FIG. 1. The audio module 280 may process sound information input or output via a speaker 282, a receiver 284, an earphone 286, the microphone 288, etc.

The camera module 291 is a device for capturing still images and moving images, and may include one or more image sensors (e.g., a front sensor or a rear sensor), lens, an Image Signal Processor (ISP), or a flash (e.g., an LED, a xenon lamp, etc.).

The power management module 295 may manage power of the electronic device 201. The power management module 295 may include a Power Management Integrated Circuit (PMIC), a charger Integrated Circuit (IC), or a battery gauge. The PMIC may use wired and/or wireless charging schemes. The wireless charging scheme may include, for example, a magnetic resonance type, a magnetic induction type, an electromagnetic type, etc., and may further include an additional circuit for wireless charging, for example, a coil loop, a resonant circuit, a rectifier, etc. The battery gauge may measure, for example, a residual quantity of the battery 296 and a voltage, a current, and a temperature during charging. The battery 296 may include a rechargeable battery and/or a solar battery.

The indicator 297 may indicate a specific state, e.g., a booting state, a message state, a charging state, etc., of the electronic device 201 or a part thereof (e.g., the processor 210).

The motor 298 may convert an electric signal into a mechanical vibration, and generates vibration, haptic effects (e.g., haptic feedback or force feedback), etc.

Although not shown, the electronic device 201 may include a processing unit (e.g., a GPU) for supporting a mobile TV. The processing unit for supporting the mobile TV may process media data according to a protocol of, for example, Digital Multimedia Broadcasting (DMB)), Digital Video Broadcasting (DVB), or mediaFlo™.

According to an embodiment of the present disclosure, each of the above-described component elements of hardware may be configured with one or more components, and the names of the corresponding component elements may vary based on the type of the electronic device. The electronic device according to various embodiments of the present disclosure may include at least one of the aforementioned elements. Some elements may be omitted or other additional elements may be further included in the electronic device. Also, some of the hardware components may be combined into one entity, which may perform functions identical to those of the relevant components before the combination.

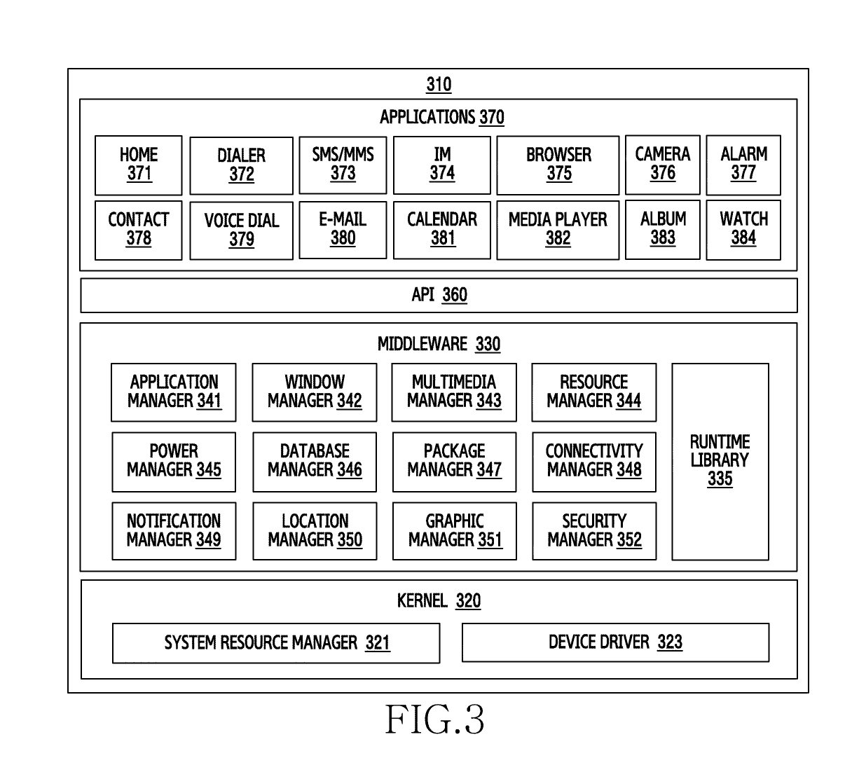

FIG. 3 is a block diagram of a program module of an electronic device, according to an embodiment of the present disclosure.

Referring to FIG. 3, a program module 310 is provided. The program module 310 (e.g., the program 150) may include an OS that controls resources associated with electronic device 101 and/or a variety of applications (e.g., the application program 157) driven on the OS. The OS may be, for example, Android™, iOS™, Windows™, Symbian™, Tizen™, Samsung bada OS™, etc.

The program module 310 may include a kernel 320, a middleware 330, an Application Programming interface (API) 360, and/or applications 370. At least a part of the program module 310 may be preloaded on the electronic device 101, or downloaded from an external electronic device (e.g., the first external electronic devices 102, the second external electronic device 104, the server 106, etc.).

The kernel 320 (e.g., the kernel 15 may include a system resource manager 321 and a device driver 323.

The system resource manager 321 may perform the control, allocation, recovery, etc. of system resources. The system resource manager 321 may include a process management unit, a memory management unit, a file system management unit, etc.

The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

The middleware 330 may provide a function commonly by the applications 370, or may provide a function to the applications 370 through the API 360 in order to enable the applications 370 to efficiently use limited system resources within the electronic device 101. The middleware 330 (e.g., the middleware 153) may include at least one of a content manager, a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The content manager may store subject content, which is created or edited through the applications 370, in a memory (e.g., a memory or a database included in the electronic device or an external electronic device) through the kernel 320 (e.g., the device driver 323). According to an embodiment, the content manager may designate (e.g., store) one or more pieces of execution content, which are referred to (e.g., used or executed) when the subject content is created or edited through the applications 370, as reference information for the subject content.

The content manager may provide reference information, which is stored in the memory (e.g., the memory included in the electronic device or the external electronic device) through the kernel 320 (e.g., the device driver 323), through the applications 370. According to an embodiment, when the subject content is displayed through the applications 370, the content manager may identify the reference information for the subject content through the kernel 320. The content manager may provide the identified reference information through the applications 370 in relation to the subject content. According to an embodiment, the content manager may execute at least some functions of the content management module 110 of FIG. 1.

The runtime library 335 may include a library module used by a complier, in order to add a new function by using a programming language during the execution of the application 370. The runtime library 335 may perform functions which are related to the management of input and output, the management of a memory, an arithmetic function, etc.

The application manager 341 may manage a life cycle of at least one of the applications 370.

The window manager 342 may manage Graphical User Interface (GUI) resources used on a screen.

The multimedia manager 343 may detect a format required for reproducing various media files and encode or decode a media file through a codec appropriate for the relevant format.

The resource manager 344 may manage resources, such as a source code, a memory, a storage space, etc, of at least one of the applications 370.

The power manager 345 may operate with a Basic Input/Output System (BIOS) to manage a battery or power, and provide information and the like required for the operation of the electronic device 101.

The database manager 346 may manage a database in such a manner as to enable the generation, search and/or change of the database to be used by at least one of the applications 370.

The package manager 347 may manage the installation and/or update of one of the applications 370 distributed in the form of a package file.

The connectivity manager 348 may manage a wireless connection such as Wi-Fi or Bluetooth.

The notification manager 349 may display or report, to a user, an event, such as an arrival of a message, an appointment, a proximity alarm, etc., in such a manner as not to disturb the user.

The location manager 350 may manage location information of the electronic device.

The graphic manager 351 may manage a graphic effect which is to be provided to the user, and/or a user interface related to the graphic effect.

The security manager 352 may provide various security functions required for system security, user authentication, etc.

When the electronic device 101 has a telephone function, the middleware 330 may further include a telephony manager for managing a voice telephony call function or a video telephony call function of the electronic device 101.

The middleware 330 may include a middleware module that forms a combination of various functions of the above-described components. The middleware 330 may provide modules specialized according to types of OSs in order to provide differentiated functions. Also, the middleware 330 may dynamically delete some of the existing components, or add new components.

The API 360 (e.g., the API 155) may be a set of programming functions, each of which is provided with a different configuration according to an OS. For example, in the case of Android™ or iOS™, one API set may be provided to each platform, and in the case of Tizen™, two or more API may set may be provided to each platform. According to an embodiment, the API 360 may perform at least some functions of the content management module 110 of FIG. 1. For example, the API 360 may request the middleware 330 or the kernel 320 to store execution content, which is referred to when subject content is created or edited through the applications 370, as reference information for the subject content. For example, in order to provide reference information for the subject content, which is displayed through the applications 370, to a user through the applications 370, the API 360 may acquire the reference information from the middleware 330 or the kernel 320.

The applications 370 (e.g., the application programs 157) may include, for example, one or more applications that can perform functions, such as a home 371, a dialer 372, an SMS/Multimedia Message Service (MMS) 373, an Instant Message (IM) 374, a browser 375, a camera 376, an alarm 377, a contact 378, a voice dial 379, an electronic mail (e-mail) 380, a calendar 381, a media player 382, an album 383, and a watch 384. The applications 370 may additionally include a health care (e.g., measuring momentum, a blood glucose, etc.) application, an environmental information providing (e.g., providing atmospheric pressure, humidity, temperature information, etc.) application, etc.

The applications 370 may include an application (hereinafter, for convenience of description, referred to as “information exchange application”) for supporting information exchange between the electronic device 101 and the first external electronic device 102 and the second external electronic device 104. The information exchange application may include, for example, a notification relay application for relaying specific information to the external electronic device or a device management application for managing the external electronic device.

For example, the notification relay application may include a function for relaying, to the first external electronic device 102 and/or the second external electronic device 104, notification information generated from other applications (e.g., SMS/MMS application, e-mail application, health care application, environmental information application, etc.) of the electronic device 101. Also, the notification relay application may receive notification information from the first external electronic device 102 and/or the second external electronic device 104 and provide the received notification information to the user.

The device management application manages (install, delete, or update), for example, one or more functions (e.g., turn-on/turn-off of the external electronic device itself (or some components) or adjustment of brightness (or resolution) of a display) of the first external electronic device 102 and the second external electronic device 104 communicating with the electronic device 101, applications operated in the first external electronic device 102 and the second external electronic device 104, or services (e.g., call service or message service) provided from the first external electronic device 102 and the second external electronic device 104.

The applications 370 (e.g., SMS/MMS 373, IM 374, Browser 375, Camera 376, E-mail 380, Media player 382, or Album 383) may create or edit subject content. According to an embodiment, the applications 370 may provide (e.g., display) subject content or reference information for the subject content.

The applications 370 may include an application (e.g., a health care application of a mobile medical device) predefined according to an attribute of the first external electronic device 102 and the second external electronic device 104. The applications 370 may include an application received from the first external electronic device 102, the second external electronic device 104, or the server 106. The application 370 may include a preloaded application or a third party application that can be downloaded from a server 106. Names of the components of the program module 310 may vary according to the type of the OS.

According to various embodiments, at least a part of the program module 310 may be implemented in software, firmware, hardware, or a combination of at least two thereof. The at least a part of the program module 310 may be implemented (e.g., executed) by, for example, a processor (e.g., the processor 210). The at least a part of the program module 310 may include, for example, a module, a program, a routine, a set of instructions, a processor, or the like for performing one or more functions.

The term “module” as used herein may refer to a unit including one of hardware, software, and firmware, or a combination of them. The term “module” may be interchangeably used with the terms “unit”, “logic”, “logical block”, “component”, and “circuit”. The “module” may be a minimum unit of an integrated component element or a part thereof. The “module” may be a minimum unit for performing one or more functions or a part thereof. The “module” may be mechanically or electronically implemented. For example, the “module” may include at least one of an Application-Specific Integrated Circuit (ASIC) chip, a Field-Programmable Gate Arrays (FPGA), and a programmable-logic device for performing operations which are known or are to be developed hereinafter.

According to various embodiments, at least some of the devices (or modules or functions thereof) or the method of the present disclosure may be implemented by a command or an instruction stored in a computer-readable storage medium in a programming module form. The instruction, when executed by a processor 130, causes the one or more processors to execute the function corresponding to the instruction. The computer-readable storage medium may be, for example, the memory 140.

The computer readable recoding medium may include a hard disk, a floppy disk, magnetic media (e.g., a magnetic tape), optical media (e.g., a Compact Disc-ROM (CD-ROM) and a DVD), magneto-optical media (e.g., a floptical disk), a hardware device (e.g., a ROM, a RAM, a flash memory), etc.

In addition, the instructions may include high class language codes, which can be executed in a computer by using an interpreter, as well as machine codes made by a compiler.

The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order, may be omitted, or other operations may be added. Further, the embodiments disclosed in this document are only for the description and understanding of technical contents and do not limit the scope of the present disclosure. Accordingly, the scope of the present disclosure should be construed as including all modifications and various other embodiments based on the technical idea of the present disclosure.

FIG. 4 illustrates a content service environment using electronic devices, according to an embodiment of the present disclosure.

Referring to FIG. 4, a content service environment 400 using a plurality of electronic devices 410, 440, and 480, is provided. A user may create (e.g., compose or edit), share, store, or read subject content 411 using at least one of the plurality of electronic devices 410, 440, and 480.

A content service is provided to the user through the content service environment 400. The content service may include a document collaboration service (e.g., an online word processor or an open word processor) in which one or more users collaborate in working on a document using at least one of the plurality of electronic devices 410, 440, and 480. For example, a first user (e.g., a writer) may create or edit a document using the document collaboration service. In addition, using the document collaboration service, the first user may store his/her own created or edited document (or updates a pre-stored document) to share the document with a second user (e.g., a reader or coworker). Accordingly, the second user may read or re-edit the document created or edited by the first user, using the document collaboration service. The second user, for example, may copy (or capture) at least a portion of the document created by the first user and then use (e.g., insert or paste) the copied portion for his/her own separately created or edited document, by using the document collaboration service.

The content service environment 400 may include the content creation device 410 (e.g., the electronic device 101, the first external electronic device 102, the second external electronic device 104, or the server 106), the content management device 440 (e.g., the electronic device 101, the first external electronic device 102, the second external electronic device 104, or the server 106), and the content providing device 480 (e.g., the electronic device 101, the first external electronic device 102, the second external electronic device 104, or the server 106), as the plurality of electronic devices.

The content creation device 410, the content management device 440, or the content providing device 480 may include at least a part of a content management module 110 according to the function, role, or capability provided thereby.

The content creation device 410 may create or edit the subject content 411 based on a writer's input, the content management device 440 may store the subject content 411 or provide it to another electronic device, and the content providing device 480 may provide the subject content 411 based on a reader's request to allow the reader to read the subject content 411. The subject content 411 may include, for example, a messenger, a message, a source code, a web page, a document, e-mail, text, an image, a video, multimedia, an icon, a symbol, a hyperlink, a sound (e.g., a voice), or a document.

The content creation device 410, the content management device 440, and the content providing device 480 have different names for convenience of description, but the names do not refer to terms assigned according to the functions, capabilities, or roles thereof. For example, at least some of the content creation device 410, the content management device 440, and the content providing device 480 may be the same electronic device having the same function or capability. The content creation device 410 may create (e.g., composes, outputs, or acquires) the subject content 411 or edit the subject content 411 (e.g., deletes, modifies, or moves some information of the subject content 411 or insert or add new information thereto) according to a writer's input. The content creation device 410 may execute at least one piece of content (hereinafter, “arbitrary content”) relating to the subject content 411. For example, the arbitrary content 415 relating to the subject content 411 may be executed in a manual manner based on the writer's input or in an automatic manner based on contextual information (e.g., the contents of the subject content 411 or time) relating to the content creation device 410.

For example, in order to create the subject content 411 (e.g., document), automatically or based on a user input, the content creation device 410 may access first content 421 (e.g., web page) through a web browser, open second content 423 (e.g., another document or multimedia) stored in a local disk, execute third content 425 (e.g., e-mail) to be added to the subject content 411, or receive fourth content 427 (e.g., message) unconnected with the contents of the subject content 411. Accordingly, the first content 421, second content 423, third content 425, and fourth content 427 are included in the arbitrary content 415. The arbitrary content 415 may be of the same or a similar type to that of the subject content 411.

The content creation device 410 may select, for example, the first content 421, second content 423, and third content 425 related to the creation or editing of the subject content 411, as execution content 429. The content creation device 410 may designate (or store) the execution content 429 as reference information 463 for the subject content 411. The content creation device 410 may transmit at least some information associated with the subject content 411 or the execution content 429 (e.g., the subject content 411 itself or the execution content 429 itself, or link information for acquiring the information associated with the subject content 411 or the execution content 429) to the content management device 440 or the content providing device 480 in order to provide the same to a reader.

The content management device 440 may store the subject content 411 using at least some information of the subject content 411 (e.g., some contents of the subject content 411 and identification information thereof (e.g., the title or the Internet address of the subject content 411, or the memory location where the subject content 411 is stored). In addition the content management device 440 may modify the attributes (e.g., data format, resolution, or size) of at least some of the subject content 411 or compress the same to store the subject content 411.

The content management device 440 may store the subject content 411 or the execution content 429 which corresponds to the first content 421, second content 423, and third content 425 in a content database 460 (e.g., the memory 140) functionally connected to the content management device 440. The content management device 440 may store, in the database 460, the execution content 429 as the reference information 463 for the subject content 411. The reference information 463 may include, for example, at least some of the execution content 429, the identification information of the execution content 429, content in which the attributes of at least some of the execution content 429 are modified, data into which the execution content 429 is compressed, or another piece of content relating to the execution content 429.

For example, the reference information 463 may include at least some contents of the first to third content 421, 423, and 425 which correspond to the execution content 429.

For example, the reference information 463 may include the title, keyword, field, stored location, or Internet address of the execution content 429 which is the identification information of the first content 421, second content 423, and third content 425. For example, the content management module 440 may modify the attributes of at least some of the first content 421, second content 423, and third content 425 or compress at least some thereof. Accordingly, the reference information 463 may include content in which the attributes of at least some of the first content 421, second content 423, and third content 425 are modified, or data into which at least some of the first content 421, second content 423, and third content 425 are compressed.

Alternatively, the reference information 463 may include another piece of content relating to the first content 421, second content 423, and third content 425 (e.g., content including more specific information for the information included in the first execution content 421). When the first content 421 corresponds to, for example, a web site including an advertisement image for a “smart watch,” another piece of content relating to the first content 421 may be, for example, another web site including specification information (e.g., processor capability information, display information, memory information, or function information) for the “smart watch.”

The content management device 440 may group the reference information 463 and the subject content 411 corresponding thereto together as one group to store them. The content database 460 may store a plurality of pieces of content. For example, the content database 460 may store first subject content and second subject content. The first subject content and first reference information corresponding thereto may be interconnected and stored in the content database 460. In addition, the second subject content and second reference information corresponding thereto may be interconnected and stored in the content database 460. For example, the content database 460 may group the first subject content and the first reference information as a first group and the second subject content and the second reference information as a second group to store them.

Furthermore, through the content providing device 480, the content management device 440 may provide at least one piece of content (hereinafter, “target content”), as the reference information 463 for the subject content 411, among the stored first content 421, second content 423, and third content 425.

The content management device 440 may select the target content 447 based on information (e.g., feeling information, health information, or profile information) on a user who wants to read the subject content 411 (hereinafter, “reader”). The profile information on the reader may include, for example, user identification information (e.g., name or ID), preferred content information, a field of interest, specialty level, areal information, access authority, preferred visual information (e.g., a graphic user interface), preferred auditory information (e.g., preferred sound level or pitch), preferred attribute information (e.g., data format, resolution, or size), the user's age, etc.

The content management device 440 may process the target content 447 (e.g., modifies, re-creates, edits, or partially deletes the target content, or add another piece of information to the target content) based on the information on the reader. For example, if the reader is under age, the content management device 440 may delete information inappropriate for minors in the contents included in the target content 447 or may change the same into another piece of information. The content management device 440 may further process the target content 447 based on the format (e.g., color, size, shape, or area for displaying some information) designated to the content providing device 480. In this case, the content management device 440, for example, may process the subject content 411 together based on the information of the reader.

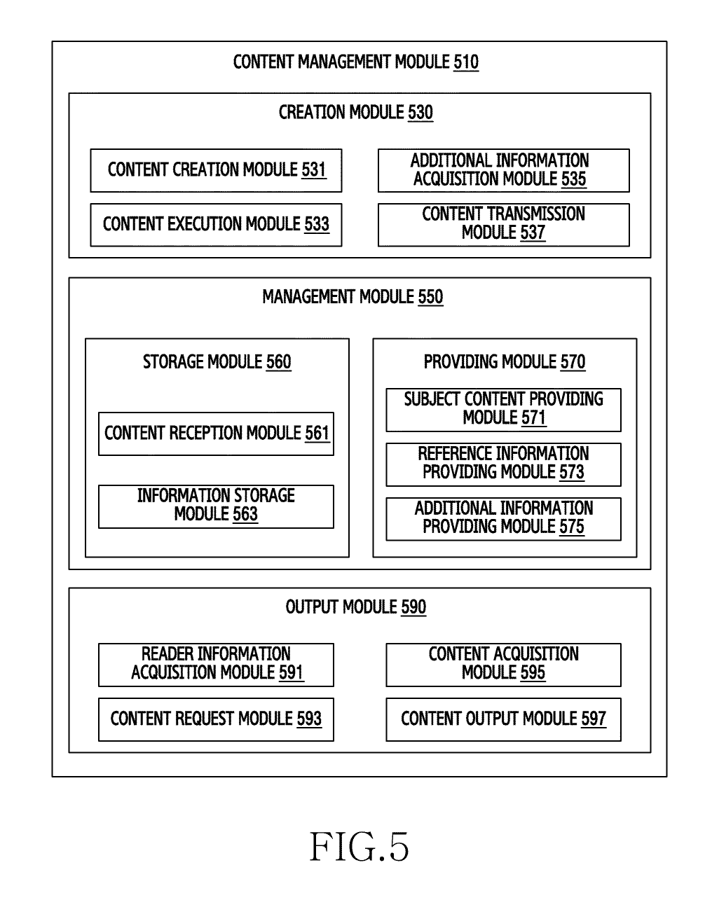

For example, the content management device 440 may modify the resolution of the subject content 411 or the target content 447 depending on the resolution of the display of the content providing device 480. When the target content 447 is stored as sound information, the content management device 440 may process the sound information into visual information (e.g., a graphic user interface) to be provided to the user. Additional information on the operations or may function of the content management device 440 will be described below in relation to FIG. 5.

The content providing device 480 may provide the subject content 411 and the target content 447, acquired from the content management device 440, by making the association between the two. For example, the content providing device 480 may provide the target content 447 through visual information 485 (e.g., a speech bubble image) connected to the subject content 411. The content providing device 480 may provide at least some of the subject content 411 based on the information of a reader. When the subject content 411 and the target content 447, received from the content management device 440, do not correspond to the format designated to the content providing device 480, the content providing device 480 may modify the subject content 411 or the target content 447 into the format corresponding to the content providing device 480.

The content creation device 410, the content management device 440, and the content providing device 480 may transmit or receive information (e.g., the subject content 411 or the execution content 429) between each other through a network 490.

The content creation device 410, the content management device 440, and the content providing device 480 are able to directly transmit or receive information between each other. For example, the content creation device 410, the content management device 440, and the content providing device 480 may directly transmit or receive information between each other using the short-range communication 164 (e.g., Device to Device (D2D) communication) or wired communication (e.g., HDMI, USB, optical interface, or D-SUB).

Some of the content creation device 410, the content management device 440, and the content providing device 480 may transmit or receive information through the network 490, and the others may directly transmit or receive information. For example, the content creation device 410 and the content management device 440, and the content creation device 410 and the content providing device 480 may transmit or receive information through the network 490, and the content management device 440 and the content providing device 480 may be directly interconnected.

For convenience of description, the content creation device 410, the content management device 440, and the content providing device 480 have been described as separate devices. However, at least a part of the content management device 440 may be included in at least one of the content creation device 410 and the content providing device 480. For example, the content creation device 410 or the content providing device 480 may include the content database 460. Accordingly, although not illustrated, the content service environment 400, for example, may include only the content creation device 410 and the content providing device 480.

For convenience of description, the content creation device 410 and the content providing device 480 have been described as different devices. However, according to various embodiments, the content creation device 410 and the content providing device 480 may be the same device. For example, a notebook computer (e.g., corresponding to both the content creation device 410 and the content providing device 480) may receive, from the content management device 440, the subject content 411 and the target content 447 which have been previously created through the notebook computer and stored in the content management device 440. In addition, the notebook computer may provide the subject content 411 (e.g., subject content previously created through the notebook computer) and the target content 447 together.

The content creation device 410 and the content providing device 480 may be the same or similar devices. For example, both the content creation device 410 and the content providing device 480 may be tablet PCs. Furthermore, the content creation device 410 and the content providing device 480 may be different devices. For example, the content creation device 410 may be a smart phone, and the content providing device 480 may be a notebook computer.

FIG. 5 is a block diagram of a content management module of an electronic device, according to an embodiment of the present disclosure.

Referring to FIG. 5, a content management module 510 of the electronic device 101 is provided. Hereinafter, the description of the same or similar parts as those described with reference to FIGS. 1 to 4 will be omitted. The content management module 510 may include a creation module 530, a management module 550, and an output module 590. The electronic device 101 may include at least a part of the content management module 510 according to the role, function, or capability thereof. For example, the content creation device 410 may include only the creation module 530; the content management device 440 may include only the management module 550; and the content providing device 480 may include only the output module 590.

In this case, providing subject content (e.g., subject content 411 of FIG. 4) or execution content (e.g., execution content 429 of FIG. 4) to the management module 550 or the output module 590 by the creation module 530 may provide that the content creation device (e.g., content creation device 410 of FIG. 4), including the creation module 530, may provide the subject content 411 to the content management device (e.g., content management device 440 of FIG. 4), including the management module 550, or the content providing device (e.g., content providing device 480 of FIG. 4), including the output module 590. Providing reference information (e.g., reference information 463 of FIG. 4) corresponding to the subject content 411 or execution content 429 to the creation module 530 or the output module 590 by the management module 510 may provide that the content management device 440, including the management module 510, may provide the subject content 411 or the reference information 463 to the content creation device 410, including the creation module 530, or the content providing device 480, including the output module 590.

Requesting first specific information from the creation module 530 by the management module 550 may request that the content management device 440, including the management module 550, may request the first specific information from the content creation device 410, including the creation module 530. Requesting second specific information from the management module 550 by the output module 590 may request that the content providing device 480, including the output module 590, may request the second specific information from the content management device 440, including the management module 550.

For example, although all of the creation module 530, the management module 550, and the output module 590, included in the content management module 510, may be implemented in one electronic device, all of them may be implemented in a plurality of electronic devices, so that the plurality of electronic devices can perform a series of operations, such as creating (e.g., composing or editing), storing, or outputting content, in conjunction with each other or independently. Hereinafter, for convenience of description, an electronic device including the creation module 530, the management module 550, and the output module 590 will be described as an example.

According to an embodiment, the content management module 510 (whole) or at least some of the creation module 530, the management module 550, and the output module 590 may be implemented as hardware, software (e.g., a software platform for information management, such as a Knowledge Management System (KMS)), or firmware capable of performing designated operations. For example, in cases where the content management module 510 is implemented as a software platform, such as a KMS, the content management module 510 may provide a package that includes Office software containing WORD™ for creating a document, multimedia playback software for playing back or editing multimedia data, a Web browser for Web search, e-mail software for sending or receiving e-mail, a search engine for search, or a term and taxonomy dictionary (e.g., taxonomy database (DB)), and may directly manage a work history (e.g., log information and relevant content) through such software products (e.g., may create or classify a DB).

Additionally or alternatively, in regard to at least some of the software products, the content management module 510 may perform a management operation after carrying out a registration procedure in relation to separate existing work software and receiving a work history, which is made through the corresponding work software, through a previously shared standard interface (e.g., an API). Each of software products may be existing general-purpose software, or native software that is implemented for the content management module 510, whether the software is included in the content management module 510, or the software is used indirectly (e.g., by using API) in relation to the content management module 510.

Furthermore, an additional information acquisition module 535 included in the creation module 530 may be included in the management module 550.

The creation module 530 may create (e.g., output), edit (e.g., modify), or transmit the subject content 411 based on a writer's input. To achieve this, the creation module 530 may include a content creation module 531, a content execution module 533, the additional information acquisition module 535, and a content transmission module 537.

The content creation module 531 may create or edit subject content 411. For example, the content creation module 531 may create or edit text, an image, a video, or multimedia, which corresponds to a writer's input, as subject content 411. For example, if the writer inputs the text “smart watch” using a keyboard, the content creation module 531 may output the text “smart watch” as subject content 411 through a display.

Furthermore, if the writer changes the text “smart watch” included in a document to the text “fitness band”, the content creation module 531 may output the text “fitness band” instead of “smart watch”, through the display, as subject content 411. For example, the content creation module 531 may output the content which the writer creates as the subject content 411 through the display functionally connected to the electronic device 101.

The content creation module 531 may create or edit subject content 411 through a content application. The content application may include, for example, a messenger application (e.g., the IM 374), a message application (e.g., the SMS/MMS 373), a web editor (e.g., a homepage building tool or a Hyper-Text Markup Language (HTML) editor), a browser a web site, Internet news, a web document, a search engine, a portal site, or a blog), a document editor (e.g., a memo application), a word processor, a spreadsheet, an e-mail application, a multimedia editor (e.g., an image editor, a video editor, or a sound editor), a multimedia player (e.g., an audio player or a video player), a scheduler (e.g., the calendar 381), a sensor application (e.g., a camera application, a voice-recording application, or a biometric application), or a telephone application (e.g., the dialer 372).

The content creation module 531 may create new content as subject content 411 through the content application.

For example, if a writer inputs dialogue content (e.g., text, a link (e.g., a hyperlink), an image, a video, a sound, or an icon) through a messenger application, the content creation module 531 may output the dialogue content as subject content 411 in a dialogue window of the messenger application.

For example, if a writer copies and pastes a source code through a web editor, the content creation module 531 may output the source code as subject content 411 in a source code input window of the web editor.

For example, if a writer inputs text, an image, or a symbol through a document editor (or a word processor), the content creation module 531 may output the text, the image, or the symbol as subject content 411 in a document.

For example, if a writer inserts a table or a graph through a spreadsheet, the content creation module 531 may output the table or the graph as subject content 411 in a document.

For example, if a writer adds a file (e.g., a text, image, or video file) to e-mail through an e-mail application, the content creation module 531 may output information (e.g., an icon or text) corresponding to the file as subject content 411.

For example, if a writer creates (e.g., draws or manufactures) an image (e.g., a picture), a video (e.g., a movie), or a sound (e.g., music) through a media editor, the content creation module 531 may output the image, the video, or the sound as subject content 411.

For example, if a writer inputs schedule information (e.g., conference time, conference site, or conference title) through a scheduler, the content creation module 531 may output the schedule information as subject content 411.

The content creation module 531 may additionally create content acquired through the content application as subject content 411.

For example, when a sensor application (e.g., a camera, voice-recording, or health application) is executed in the electronic device 101, the content creation module 531 may acquire an image, a sound, or environment information through a sensor (e.g., a camera or an image sensor), a microphone, a temperature sensor, a humidity sensor, an illumination sensor, an atmospheric pressure sensor, a UV sensor, or a motion sensor) functionally connected to the electronic device 101. In this case, the content creation module 531 may output text or an image, as subject content 411, which corresponds to the sensed image, the sound, or the environment information.

For example, when a telephone application is executed in the electronic device, the content creation module 531 may acquire contents of a telephone call (e.g., a voice). In this case, the content creation module 531 may output the contents of the telephone call (e.g., the voice or text corresponding thereto) as subject content 411.

The content creation module 531 may additionally edit at least a portion of created subject content 411.

For example, if a writer may modify a portion of the dialogue contents output in a dialogue window of a messenger application, and remove the portion of the dialogue contents and then input another piece of information, the content creation module 531 may output the modified contents as subject content 411.

For example, if a writer may move a source code input in a first area of a source code input window of a web editor to a second area of the source code input window, the content creation module 531 may output the source code as subject content 411 through the second area.

For example, if a writer may add text, an image, or a hyperlink to a partial area of a document (or e-mail) created through a document editor (or a word processor or an e-mail application), the content creation module 531 may add the text, the image, or the hyperlink as subject content 411 to the document and display the same.

For example, if the writer may change some data of a graph created through a spreadsheet into other pieces of data, the content creation module 531 may output the graph, reflecting the other pieces of data, as subject content 411.

For example, if the writer may modify some attributes (e.g., a playback speed and a resolution) of a video through a multimedia editor, the content creation module 531 may output the video, having the modified attributes, as subject content 411 to the writer.

The subject content 411 is not limited to the above-described content and may include various types of content that a user may create through the electronic device 101.

The subject content 411 may be the entirety or a portion of content created or edited by a writer.

For example, if the writer inputs the text “smart watch”, subject content 411 may be the whole text “smart watch” or may be the text “watch.” The subject content 411 may be determined based on settings made by the writer or settings designated to the electronic device. For example, a part of created or edited content may be selected through a user input. In this case, subject content 411 may be the selected part.

The subject content 411 may be designated based on a writer's input or settings of the electronic device 101. The subject content 411 may be designated as created or edited content itself or the whole content including the created or edited content. For example, a user may add the text “and a smart watch” to the text “A wearable device may include electronic glasses” to modify the text into “A wearable device may include electronic glasses and a smart watch.” in this case, subject content 411 may be the added text “and a smart watch” or the whole text “A wearable device may include electronic glasses and a smart watch.”

For convenience of description, subject content 411 has been described as created or edited (i.e., completely created and edited) content. However, according to various embodiments, the subject content 411 may include content that is in the process of being created or edited. For example, if a writer inputs only the text “a smart watch” among “includes a smart watch”, subject content may be the incompletely input text “a smart watch.”

The content execution module 533 may execute (e.g., reads, stores, reproduces, creates, or edits) arbitrary content (e.g., arbitrary content 415 of FIG. 4) relating to subject content 411.

For example, a writer may create or edit the subject content 411 with reference to the arbitrary content 415. To achieve this, based on the writer's input (e.g., a double click on an icon for reading the arbitrary content 415), the content execution module 533 may execute the arbitrary content 415 which is referred to in the creation or editing of the subject content 411.

The content execution module 533 may execute not only arbitrary content 415 having high correlation with the creation or editing of subject content 411, but also arbitrary content 415 having low correlation with the creation or editing of the subject content 411 automatically or based on a user input.

For example, although a writer may execute arbitrary content 415 (e.g., the first content 421, second content 423, and third content 425) relating to the creation or editing of subject content 411 before, while, or after the creation of the subject content 411, the writer may also execute arbitrary content 415 (e.g., the fourth content 427) without the intention of creating or editing the subject content 411.

The content execution module 533 may execute arbitrary content 415 based on a writer's input at a time relating to when subject content 411 is created or edited.

For example, the writer may execute music before creating or editing a video that is subject content 411 (e.g., about one hour before the creation of the subject content) or while creating the video. In this case, the content execution module 533 may reproduce the music as arbitrary content 415.

The content execution module 533 may execute arbitrary content 415 not only through the electronic device 101 in which subject content 411 is executed, but also through an external electronic device functionally connected to the electronic device 101.

For example, if text which is subject content is created in a notebook computer including the content execution module 533, the content execution module 533 may create (e.g., execute) e-mail as arbitrary content 415 through the notebook computer in which the content execution module 533 is included.

Furthermore, if an image which is subject content is edited through a tablet PC including the content execution module 533, the content execution module 533 may identify a received message, as arbitrary content 415, received by a smart phone that is an external electronic device connected to the tablet PC through short-range communication (e.g., WiFi or Bluetooth).

The content creation module 533 executes arbitrary content 415 through a content application.

For example, the content execution module 533 may open, create, edit, transmit, receive, store, delete, or print a message as arbitrary content 415 through a messenger application (or a message application).

As another example, the content execution module 533 may open, create, edit, transmit, store, delete, or print a source code as arbitrary content 415 through a web editor.

As another example, the content execution module 533 may open, create, edit, update, store, print, or search for a web site, Internet news, a web document, a search engine, a portal site, or a blog as arbitrary content 415 through a browser.

As another example, the content execution module 533 may open, create, edit, transmit, store, or delete a text document or multimedia document as arbitrary content 415 or may print the same on paper through a document editor.

As another example, the content execution module 533 may open, receive, send, un-send, create, edit, delete, preserve, store, or search for e-mail as arbitrary content 415 or may print the same on paper through an e-mail application.

As another example, the content execution module 533 may open, create, edit, transmit, store, copy, or delete an image, a video, or multimedia as arbitrary content 415 or may print the same on paper through a multimedia editor.

As another example, the content execution module 533 may reproduce, transmit, store, copy, or delete a movie, music, or an image as arbitrary content 415 through a multimedia player.

As another example, the content execution module 533 may open, create, edit, transmit, store, or delete schedule information as arbitrary content 415 or may print the same on paper through a scheduler.

The content execution module 533 may acquire a photo, a video, a sound, or environment information as arbitrary content 415 through a sensor application. The content execution module 533, for example, may recognize or record contents of a telephone call (e.g., a voice or text corresponding thereto) as arbitrary content 415 through a telephone application.

The arbitrary content 415 may be executed (e.g., operated) to be independent of subject content 411.

For example, the subject content 411 may be first dialogue contents input through a first messenger window, and the arbitrary content 415 may be second dialogue contents input through a second messenger window. The arbitrary content 415 may be executed through a different content application from the subject content 411. For example, the subject content 411 may be an image created through a multimedia editor, and the arbitrary content 415 may be a web site executed through a browser.

The additional information acquisition module 535 acquires content information as additional information for subject content 411 or arbitrary content 415. The content information may include, for example, contents of the subject content 411 or the arbitrary content 415 (e.g., summary information or main contents), identification information (e.g., a location where data is stored, an Internet address, or a content type), or link information (hierarchy information) between the subject content 411 and the arbitrary content 415.

For example, if subject content 411 is the text “smart watch” or a document including contents for a camera or gallery function, the additional information acquisition module 535 may acquire only the contents for the camera function, which is the main function of the “smart watch”, as additional information for the subject content 411.

For example, if arbitrary content 415 is a web site, the additional information acquisition module 535 may acquire the address of the web site and the information that the type of arbitrary content 415 is “web site”, as additional information for the arbitrary content 415.

For example, first and second arbitrary content 415 may be executed in order to directly create or edit subject content 411. In contrast, third arbitrary content 415 may be indirectly executed in conjunction with the first arbitrary content 415 (e.g., may be executed by a click on the hyperlink corresponding to the third arbitrary content included in the first arbitrary content).

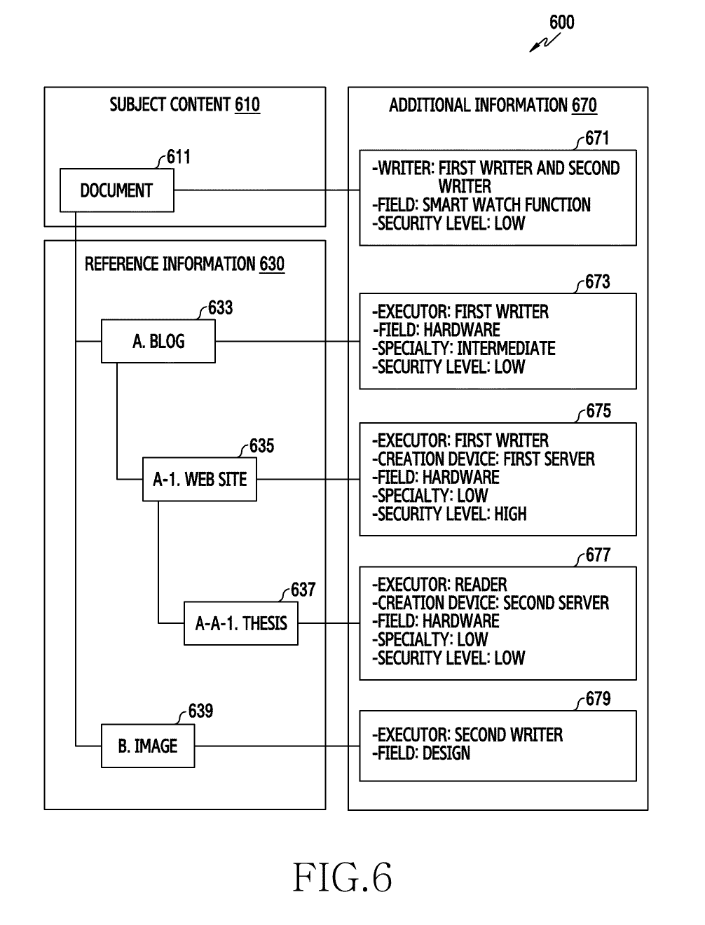

The additional information acquisition module 535 may determine the first and second arbitrary content 415 to be on the same hierarchy for the subject content 411, and may determine the third content to be on a lower hierarchy for the first arbitrary content 415. In this case, the additional information acquisition module 535 may acquire hierarchy information for the first to third arbitrary content 415 as additional information. Additional description of the hierarchy information will be given below in relation to FIG. 6.

The additional information acquisition module 535 may acquire activity information as additional information for subject content 411 or arbitrary content 415. The activity information may include, for example, the number of times that the subject content 411 or the arbitrary content 415 is executed, or execution sequence or time thereof. The activity information may further include, for example, a writer's motion such as opening, reading, identifying, or reproducing, creating, editing, searching, transmitting, receiving, un-sending, preserving, updating, storing, deleting, acquiring (e.g., shooting, recognizing, or recording), purchasing, or printing relating to the subject content 411 or the arbitrary content 415.

For example, when subject content 411 has been created for over about three hours, for example, the additional information acquisition module 535 may store “about three hours,” as additional information for the subject content 411, which is the creation time of the subject content 411 which is a document.

For example, when e-mail, which is arbitrary content 415, is transmitted based on a writer's input, the additional information acquisition module 535 may store “transmission”, which the writer has finally executed for the e-mail, as additional information for the arbitrary content 415.

The additional information acquisition module 535 may acquire surrounding information of the electronic device 101, which executes (e.g., creates or edits) subject content 411 or arbitrary content 415, as additional information. The surrounding information may include, for example, temperature, humidity, intensity of illumination, sound, pressure, stoichiometry information (e.g., the amount of oxygen or carbon dioxide), or olfactory information (e.g., the scent of a flower, the smell of food, toxic gas, or fire detection) near the electronic device 101.

For example, the additional information acquisition module 535 may acquire temperature information near the electronic device 101 as additional information for subject content 411 or arbitrary content 415 while the subject content 411 or the arbitrary content 415 is being executed in the electronic device 101.

The additional information acquisition module 535 may acquire information on a writer who executes subject content 411 or arbitrary content 415, as additional information. The information on the writer may include, for example, feeling information (e.g., pleasant, positive, negative, grief, or angry), health information (e.g., heart rate, temperature, degree of fatigue, or stress index), motion information, or the writer's profile information. The writer's profile information may include, for example, user identification information (e.g., name, ID, or biometric information (e.g., fingerprint, vein, iris, or face)), preferred content information, a field of interest, specialty level, areal information, access authority, preferred visual information (e.g., a preferred graphic user interface, color, size, shape, or location), preferred auditory information (e.g., preferred sound level or pitch), a preferred data format, a preferred resolution, preferred activity for content (e.g., copy, paste, or highlight), preferred surrounding information (e.g., temperature or humidity), or the writer's age.

The additional information acquisition module 535 may acquire additional information (e.g., emotional information) through a sensor (e.g., a heart rate monitor (HRM) sensor, a camera, a brain-wave sensor, an input device, a microphone, etc.) that is functionally connected thereto. For example, the additional information acquisition module 535 may acquire a user's heart rate through an HRM sensor, and may acquire the user's emotional information at least partially based on the heart rate. For example, the additional information acquisition module 535 may acquire a user's face or body motion through a camera, and may acquire the user's emotional information at least partially based on the face or the body motion. For example, the additional information acquisition module 535 may acquire a user input through an input device (e.g., a touch sensor, a mouse, a keyboard, etc.), and may acquire the user's emotional information at least partially based on the input pattern (e.g., meaningless continuous hits, a slap, etc.). Alternatively, the additional information acquisition module 535 may acquire the emotional information based on an input acquired from the user. For example, when a user enters emotional information through a menu provided on a user interface (UI) (e.g., a like, dislike, sympathy button, etc.), the additional information acquisition module 535 may acquire the user's emotional information based on the menu.

In cases where a plurality of writers create or edit the same subject content 411, or execute the same execution content 429, the additional information acquisition module 535 may acquire the information of the plurality of writers as additional information. For example, the additional information acquisition module 535 may acquire emotional information when each of the plurality of writers creates (or edits) subject content 411, as additional information for the subject content 411. According to an embodiment, the additional information acquisition module 535 may acquire emotional information with a higher priority (e.g., emotional information that corresponds to more writers) among the plurality of writers' emotional information, as additional information.

The additional information acquisition module 535 may acquire information on a writer based on the settings of a user or the electronic device 101.

For example, the additional information acquisition module 535 may acquire profile information directly input by the writer, as additional information for subject content 411.

For example, the additional information acquisition module 535 may set access authorization information for arbitrary content 415 by the settings of the electronic device 101 executing the arbitrary content 415 or the settings of the user creating the arbitrary content 415.

For example, when a document, which is arbitrary content 415, has a high security level, the additional information acquisition module 535 may designate a small number of people to access (e.g., read or edit) the document. In this case, the additional information acquisition module 535 may acquire information on a small number of people as additional information for the arbitrary content 415.

The additional information acquisition module 535 may further acquire information on a writer by using analyzing an execution pattern of a user who executes subject content 411 or arbitrary content 415 (e.g., the type of previously executed content).

For example, if a writer editing subject content 411 has frequently executed content relating to the text “design” (e.g., has searched for the content through a browser), the additional information acquisition module 535 may determine the user's field of interest to be “design.” in this case, the additional information acquisition module 535 may acquire “design,” which is the user's field of interest, as information on the writer.

The content transmission module 537 may provide subject content, one or more pieces of content (e.g., arbitrary content 415) executed in relation to the subject content 411, or additional information to the management module 550 or the output module 590.

According to an embodiment, the creation module 530 may be operated through one or more devices. For example, all operations of the creation module 530 may be performed through the electronic device 101. In addition, the operations of some modules (e.g., the content creation module 531 and the content transmission module 537) included in the creation module 530 may be performed through the electronic device 101, and the operations of the other modules (e.g., the content execution module 533 and the additional information acquisition module 535) included in the creation module 530 may be performed through the first external electronic device 102, the second external electronic device 104, or the server 106) connected to the electronic device 101 through wired or wireless communication.

For example, the content creation module 531 included in a notebook computer may create or edit a document as subject content 411. The content execution module 533 included in a smart phone connected to the notebook computer through short-range communication, for example, may acquire a photo shot in relation to the document, as arbitrary content 415. The additional information acquisition module 535 included in the smart phone, for example, may acquire the shooting operation as additional information. The smart phone may transmit the arbitrary content 415 and the additional information to the notebook computer. The content transmission module 537 included in the notebook computer may transmit the subject content 411, the arbitrary content 415, and the additional information to the management module 550 or the output module 590.

The management module 550 may manage (e.g., receives, stores, or provides) at least a portion (e.g., the execution content 429) of the subject content 411 and the arbitrary content 415. To achieve this, the management module 550 may include a storage module 560 and a providing module 570.

The storage module 560, for example may receive at least a portion of the subject content 411 and the arbitrary content 415 from the creation module 530 and store the same. The storage module 560 may include, for example, a content reception module 561 and an information storage module 563.

The content reception module 561 may receive subject content 411, arbitrary content 415, and additional information from the creation module 530.

For example, when the subject content 411 is created or edited through the content creation module 531, the content reception module 561 may acquire, from the content creation module 531, the subject content 411 which is being created or edited or which has been already completely created or edited. The content reception module 561 may acquire arbitrary content 415 from the content execution module 533. The content reception module 561 may acquire additional information from the additional information acquisition module 535.

The information storage module 563 may store at least a portion of the subject content 411 and the arbitrary content 415 received from the creation module 530.

For example, the information storage module 563 may store the subject content 411 and the arbitrary content 415 in a database (e.g., the database included in the memory 140 or the server 106) functionally connected to the information storage module 563.

The information storage module 563 may select at least a portion of the arbitrary content 415 as execution content 429. The information storage module 563 may connect the execution content, as the reference information 463 for the subject content 411, with the subject content 411 (i.e., groups the subject content 411 and the reference information 463 corresponding thereto together as one group) and store the same.

For example, the information storage module 563 may store the execution content 429 as the reference information 463 as metadata for the subject content 411. Additional information on a method of designating the reference information 463 for the subject content 411 will be described below in relation to FIG. 6.

Based on the correlation between subject content 411 and one or more pieces of arbitrary content 415, the information storage module 563 may determine at least some of the one or more pieces of arbitrary content 415 as execution content 429. The correlation between the arbitrary content 415 and the subject content 411 is classified into a plurality of designation degrees. For example, the correlation between the arbitrary content and the subject content may be classified into two steps including “high” and “low”.

The correlation may be classified into designation degrees, such as “very high”, “high”, “intermediate”, “low”, and “very low.” The execution content 429 may represent, for example, step (or level) which corresponds to a degree to which the correlation is designated. The degree of designation may be set, for example, to “high” or “very high”. In this case, first content with a designation degree of “low” may not be designated as execution content 429, but second content with “high” may be designated as execution content 429.

In this case, the information storage module 563 may group the first content, as execution content 429 for subject content 411, and the subject content 411 together to store the same as reference information 463 for the subject content 411, and does not store the second content. Alternatively, the information storage module 563 may independently store the second content to be separate from the subject content 411 without connecting the second content to the subject content 411. For example, the execution content 429 may include only content having correlation designated as “very high” or “high” among the one or more pieces of arbitrary content 429.

The information storage module 563 may determine the correlation between subject content 411 and arbitrary content 415 based on at least one of sub-content included the arbitrary content 415, time when the arbitrary content 415 is executed, activity information for the arbitrary content 415, and environment information for the subject content 411 or the arbitrary content 415. Hereinafter, for convenience of description, the correlation will be distinguished into “high” and “low.”

When the correlation is determined based on sub-content, first content including the same or similar content (hereinafter, “similar content”) as sub-content included in subject content 411 may have a higher correlation than second content not including the sub-content. Accordingly, the information storage module 563 may determine the correlation of the first content to be “high” to select the first content as execution content 429. In contrast, the information storage module 563 may determine the correlation of the second content to be “low” so that the information storage module 563 does not select the second content as execution content 429.

For example, the information storage module 563 may compare the subject content 411 (e.g., a document), the first content (e.g., a web site), and the second content (e.g., a messenger). When the text “smart watch” included in the subject content 411 is included in the first content, but is not included in the second content, the information storage module 563 may determine the correlation of the first content to be “high” and determine the first content as execution content 429. In contrast, the information storage module 563 may determine the correlation of the second content to be “low” and does not determine the second content as execution content 429.

The correlation of the arbitrary content 415 with subject content 411 may further increase with an increase in the number of times (e.g., frequency) that similar content is included in arbitrary content 415.

For example, when first content may include similar content a predetermined number of times or more, the information storage module 563 may determine the correlation of the first content to be “high” to select the first content as execution content 429. In contrast, when the second content may include similar content a predetermined number of times or less, the information storage module 563 may determine the correlation of the second content to be “low” so as not to select the second content as execution content 429.

For example, if the predetermined number of times is 3, and text “smart watch” is included in subject content 411 as the similar content; if the first content uses the similar content five times, and the second content uses the similar content one time, the information storage module 563 may determine the correlation of the first content; which uses the similar content more than three times, to be “high” and determine the first content as execution content 429. In contrast, the information storage module 563 may determine the correlation of the second content, which uses the similar content less than three times, to be “low” and does not determine the second content as execution content 429.

When the correlation is determined based on executed time information, arbitrary content 415 executed during the creation or editing of subject content 411 has a higher correlation than arbitrary content executed after or before the creation or editing of the subject content 411.

For example, when the first content and subject content are simultaneously executed at least for a short time, the information storage module 563 may determine the correlation of the first content to be “high” to determine the first content as execution content 429. In contrast, when the second content and the subject content 411 are executed at a different time, the information storage module 563 may determine the correlation of the second content with the subject content 411 to be “low” so as not to select the second content as execution content 429.

For example, the subject content 411 may be executed for a first time interval (e.g., from about 10:00 to about 12:00), the first content may be executed for a second time interval (e.g., from about 11:00 to about 12:00) at least partially overlapping with the first time interval, and the second content may be executed for a third time interval (e.g., from about 01:00 to about 02:00) without overlapping with the first time interval. In this case, the information storage module 563 may determine the correlation of the first content to be “high” and determine the first content as execution content 429. In addition, the information storage module 563 may determine the correlation of the second content to be “low” and does not determine the second content as execution content 429.

For example, arbitrary content 415 executed within a designated time range from when subject content 411 is created or edited (e.g., from about five minutes before the creation or editing of the subject content to when the creation or editing of the subject content starts) has a higher correlation than arbitrary content 415 executed beyond the designated time range from when the subject content 411 is created or edited (e.g., from about three hours to about one hour before the creation or editing of the subject content 411 starts).

For example, when the first content is executed within a designated time range (within about one hour) from when the subject content 411 is executed, the information storage module 563 may determine the correlation of the first content with the subject content 411 to be “high” to determine the first content as execution content 429. In contrast, when the second content is executed beyond the designated time range (e.g., after about one hour) from when the subject content 411 is executed, the information storage module 563 may determine the correlation of the second content with the subject content 411 to be “low” does not determine the second content as execution content 429.

The designated time range may be a time range in which it may be determined that the arbitrary content 415 has been executed in order to be directly used in the creation or editing of the subject content 411 (e.g., in order to add a portion of the execution content 429 to the subject content 411). The designated time range may be set automatically in the electronic device 101 or manually by a user input.

The correlation may additionally be determined based on content information (e.g., contents of content, identification information, or link information between content) for arbitrary content 415.

For example, when the content information of the first content is the same as or similar to that of the subject content 411, the information storage module 563 may determine the correlation of the first content to be “high” to determine the first content as execution content 429. In contrast, when the content information of the second content is different from that of the subject content 411, the information storage module 563 may determine the correlation of the second content with the subject content 411 to be “low” so as not to determine the second content as execution content 529.

For example, if the main content of the subject content is “a function of a smart watch”, the main content of the first content is “a camera function of a smart watch”, and the main content of the second content is “a function of a notebook computer”, the information storage module 563 may determine the correlation of the first content to be “high” and determine the first content as execution content 429. In addition, the information storage module 563 may determine the correlation of the second content to be “low” and does not determine the second content as execution content 429.

The correlation may additionally be determined based on activity information for arbitrary content 415.

For example, the information storage module 563 may determine whether a designated activity (hereinafter, “target activity”) relating to the creation of editing of the subject content 411 has occurred for the arbitrary content 415. For example, the first content including the target activity may have a higher correlation than the second content not including the target activity. In this case, the information storage module 563 may determine the correlation of the first content to be “high” and determine the first content as execution content 429. In contrast, the information storage module 563 may determine the correlation of the second content to be “low” so as not to determine the second content as execution content 429.

The target activity may include an operation connected to the operation of creating the subject content 411.

For example, the information storage module 563 may set an operation of copying at least a portion of a web page, which is target content 447, in order to insert the same into a document, which is subject content 411, as a target activity.

For example, if the execution operation of the first content may include an operation of copying subject content 411, and the execution operation of the second content may include an operation of deleting subject content 411, the information storage module 563 may determine the correlation of the first content to be “high” and may determine the first content as execution content 429. In addition, the information storage module 563 may determine the correlation of the second content to be “low” and does not determine the second content as execution content 429.

The correlation may additionally be determined based on surrounding environment information of the electronic device 101 in which arbitrary content 415 is executed. For example, the first content executed in a pleasant environment (e.g., pleasant temperature (e.g., from about 19° C. to about 24° C.), pleasant humidity, or a low-noise-level environment) may be more useful (e.g., may have a higher correlation with the subject content 411) than the second content executed in an unpleasant environment (e.g., unpleasant temperature (e.g., uncomfortably high or low temperature (e.g., about +40° C. or about −10° C.)), unpleasant humidity (e.g., about 80%), or a high-noise-level environment).

For example, if the temperature acquired when the first content is executed is a pleasant temperature (e.g., about 20° C.), and the temperature acquired when the second content is executed is a higher temperature (e.g., about 30° C.) than the pleasant temperature, the information storage module 563 may determine the correlation of the first content to be “high” and determine the first content as execution content 429. In contrast, the information storage module 563 may determine the correlation of the second content to be “low” and does not determine the second content as execution content 429.

The correlation may additionally be determined based on information on a writer (e.g., feeling information, health information, or profile information). For example, the first content executed by a user who is also the writer of the subject content 411 has a higher correlation than the second content executed by another user.

When the writer information of the first content is the same as or similar to that of the subject content 411, the information storage module 563 may determine the correlation of the first content to be “high” to determine the first content as execution content 429. In contrast, when the writer information of the second content is different from that of the subject content 411, the information storage module 563 may determine the correlation of the second content with the subject content 411 to be “low” so as not to determine the second content as execution content 429.

For example, if a first fingerprint is acquired in relation to the writer and a user who executes the first content, and a second fingerprint is acquired in relation to a user who executes the second content (and is not the writer), the information storage module 563 may determine the correlation of the first content to be “high” and determine the first content as execution content 429. In addition, the information storage module 563 may determine the correlation of the second content to be “low” and does not determine the second content as execution content 429.

When the writer information for the first content is designated writer information (hereinafter, “target writer information”), the information storage module 563 may determine the correlation of the first content to be “high” to determine the first content as execution content 429. In contrast, when the writer information of the second content does not correspond to the target writer information, the information storage module 563 may determine the correlation of the second content to be “low” so as not to determine the second content as execution content 429. The target writer information may include, for example, a user's health condition or emotional state, or motion information for executing execution content 429.

For example, the first content executed when the user's health condition is good (e.g., a low-stress/fatigue state or a normal heart-rate/temperature state) or in when the user's emotional state is good (e.g., pleasant or positive) may be more useful (e.g., may have a higher correlation with the subject content) than the second content executed when the user's health condition is poor (e.g., a high-stress/fatigue state or an abnormal heart-rate/temperature state) or when the user's emotional state is poor (e.g., negative or grief).

For example, the information storage module 563 may set a “normal range of a stress index” of the writer as the target writer information. If the writer's stress index when executing the first content is within a normal range, and the writer's stress index when executing the second content is within a higher range than the normal range, the information storage module 563 may determine the correlation of the first content to be “high” and determine the first content as execution content 429. In addition, the information storage module 563 may determine the correlation of the second content to be “low” and does not determine the second content as execution content 429.

The information storage module 563 may set the writer's designated motion (e.g., gesture) information for executing arbitrary content 415 as the target writer information.

For example, when the writer wears a smart watch on his/her arm, the writer may raise his/her arm in order to identify execution content 429 executed in the smart watch.

For example, the information storage module 563 may set a “motion of raising an arm” as the target writer information. When the first content is executed, if the user's motion of raising the arm may be sensed, and when the second content is executed, the user's motion of raising the arm may not be sensed, the information storage module 563 may determine the correlation of the first content to be “high” and decide the first content as execution content 429. In addition, the information storage module 563 may determine the correlation of the second content to be “low” and does not determine the second content as execution content 429.

The method of determining the correlation is not limited to the above-described embodiments, and may include various methods for determining the relation of execution content 429 to subject content 411.

The reference information 463 may include not only execution content 429 executed by the electronic device 101 or by one writer but also a plurality of pieces of execution content 429 executed by a plurality of electronic devices or writers. The reference information 463 may include not only execution content 420 primarily executed in relation to the creation or editing of subject content 411 but also another piece of content secondarily executed in order to obtain more specific information on the execution content. Additional information on a method of designating reference information 463 will be described below in relation to FIG. 6.

The information storage module 563 may store additional information for at least one of subject content 411 and execution content 429. For example, the information storage module 563 may connect the additional information for the subject content 411 or the execution content 429 with the corresponding content among the subject content 411 and the execution content 429 to store the same (e.g., as metadata of the corresponding information). Additional information on a method of connecting and storing reference information will be described below in relation to FIG. 6.

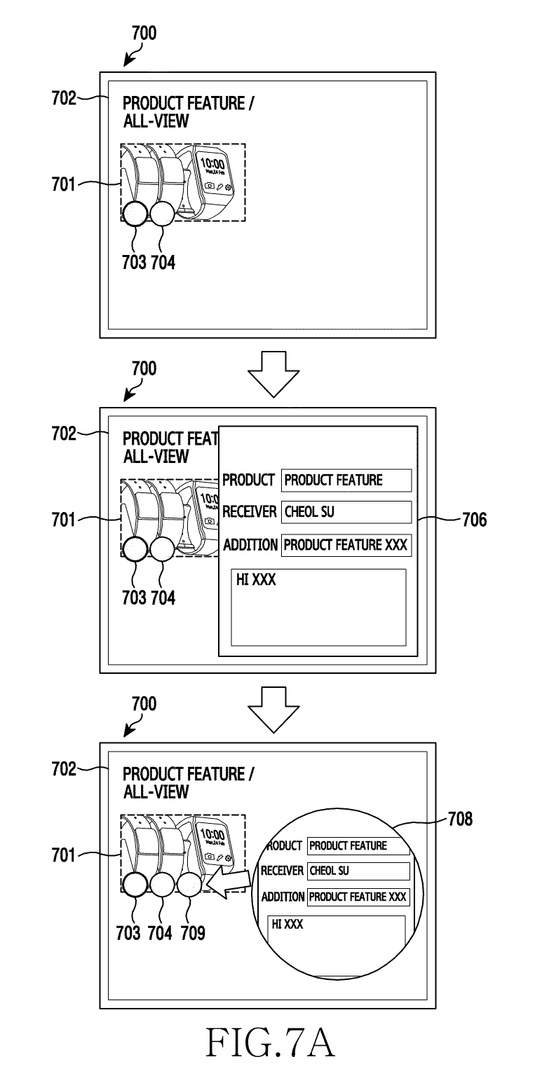

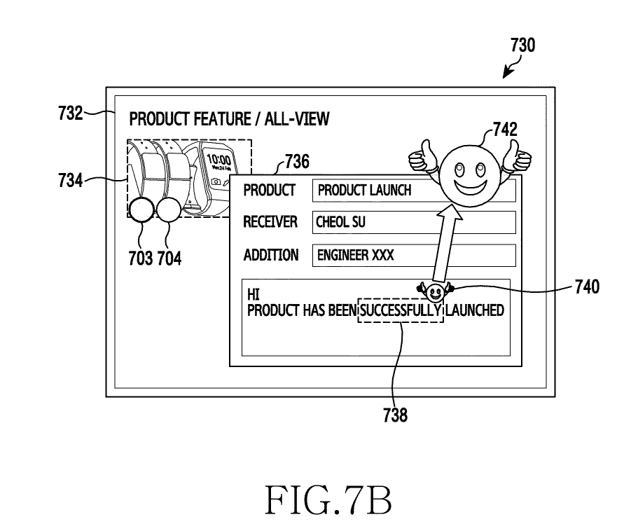

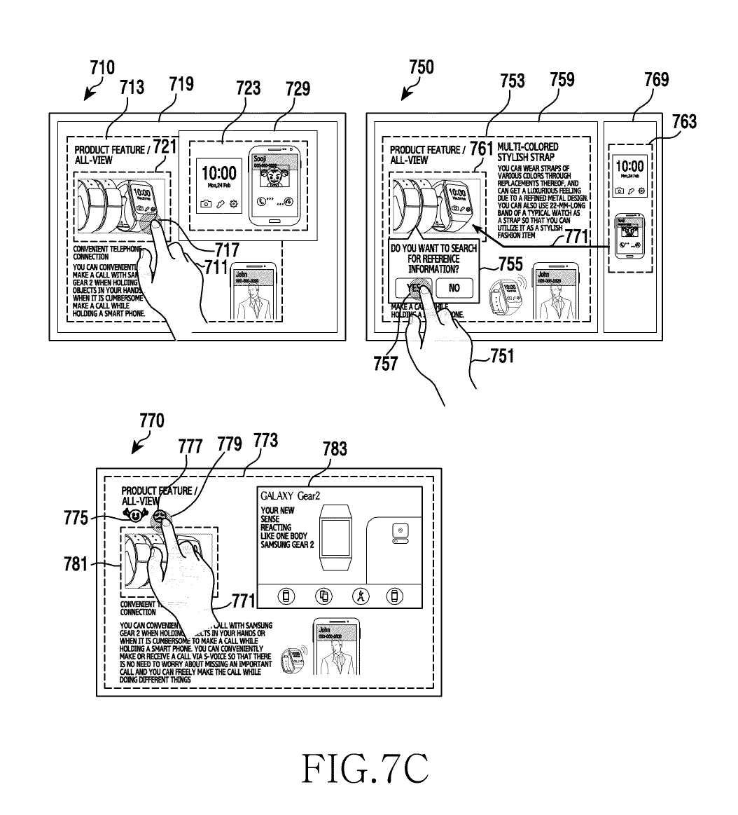

The information storage module 563 may provide the arbitrary content 415 in relation to subject content 411 based on the fact that arbitrary content 415 is stored as execution content 429. Additional information on a method of providing the arbitrary content 415 (or execution content 429) will be described below in relation to FIG. 7A. According to an embodiment, based on the fact that additional information on at least one of the subject content 411 and the arbitrary content 415 (or execution content 429) is stored, the information storage module 563 may provide the additional information in relation to at least one of the subject content 411 or the arbitrary content 415 (e.g., execution content 429). Additional information on a method of providing the additional information will be described below in relation to FIG. 7B.

The providing module 570 may provide at least one of, for example, the subject content 411, the target content 447 of reference information 463 corresponding to the subject content 411, and additional information to a reader. The providing module 570 may provide (e.g., transmits) subject content 411 or at least one piece of execution content 429 to the output module 590 in relation to the subject content 411 such that the target content 447 of a plurality of pieces of execution content 429 stored as reference information 463 may be provided to a reader in relation to the subject content 411. To achieve this, the providing module 570 may include, for example, a subject content 411 providing module 571, a reference information providing module 573, and an additional information providing module 575.

The subject content providing module 571 may provide at least some contents of subject content 411 to the output module 590 based on a request of the output module 590 for the subject content 411 (e.g., a request for outputting or reading the subject content).

For example, when the output module 590 makes a request for reading first subject content, the subject content providing module 571 may provide the first subject content 411 to the output module 590. Furthermore, when the output module 590 makes a request for reading second subject content, the subject content providing module 571 may provide the second subject content 411 to the output module 590.

The subject content providing module 571 may identify subject content 411 to be provided to the output module 590 through the content database 460. For example, only some contents of the subject content 411 may be stored in the content database 460 through the storage module 560. In this case, the subject content providing module 571 may identify (e.g., acquires or search for) the whole contents of the subject content 411 through the content database 460 or another database using the contents.

For example, if identification information of subject content 411 (e.g., the title of the subject content 411, a memory location where the subject content 411 is stored, or the Internet address corresponding to the subject content 411) is stored in the content database 460 through the storage module 560, the subject content providing module 571 may acquire subject content 411 using the identification information. For example, using the title of subject content 411 stored in the content database 460, the subject content providing module 571 may acquire the subject content 411 corresponding to the title from another database functionally connected to an electronic device 101 in which the subject content 411 is stored.

For example, if subject content 411, at least a portion of which has a modified attribute, is stored in the content database 460 through the storage module 560, the subject content providing module 571 may acquire the subject content 411 by modifying the attribute of at least a portion of the stored subject content 411 again. For example, if subject content 411 (e.g., an image), the attribute of which is changed from a first attribute (a data format of Joint Photographic Experts Group (JPEG)) to a second attribute (a data format of Portable Network Graphics (PNG)) is stored in the database, the subject content providing module 571 may change the attribute of the stored subject content 411 from the second attribute to the first attribute again to acquire the subject content 411 having the same attribute as that created by a writer (e.g., the image having the JPEG data format).

For example, if subject content, at least a portion of which is compressed, may be stored in the content database 460 through the storage module 560, the subject content providing module 571 may acquire the subject content 411 by decompressing (e.g., decoding) the compressed subject content 411. The subject content providing module 571, for example, decompresses the compressed subject content 411 based on the compression format of the subject content 411 by which at least a portion of the subject content 411 has been compressed.

The subject content providing module 571 may modify at least a portion of subject content 411 and provide the same to the output module 590. For example, the subject content providing module 571 may modify the attribute of the subject content 411 to an attribute supported by the output module 590 to output the subject content 411 or an external electronic device. The subject content providing module 571 may transmit the modified subject matter 411 to the output module 590.

The subject content providing module 571 may modify at least a portion of subject content 411 based on information on a reader who identifies (e.g., receives, reads, or executes) the subject content 411 (e.g., based on reader information acquired through the output module 590) and provide the subject content to the output module 590. For example, the subject content 411 may include first sub-content and second sub-content. The subject content providing module 571 may provide only the first sub-content to the output module 590 when the reader information is first reader information and only the second sub-content to the output module 590 when the reader information is second reader information. Furthermore, when the reader information is the first reader information, the subject content providing module 571 may modify the subject content 411 to a first format (e.g., a first color, size, or shape). In contrast, when the reader information is the second reader information, the subject content providing module 571 may modify the subject content 411 to a second format (e.g., a second color, size, or shape) different from the first format.

The reference information providing module 573 may provide execution content in conjunction with subject content 411 to the output module 590. The reference information providing module 573 may acquire or receive a request for reading execution content 429 corresponding to subject content 411 from the output module 590. For example, when the output module 590 requests the reading of execution content 429 for first subject content, the reference information providing module 573 may provide, to the output module 590, first execution content 429 corresponding to the first subject content 411 which is identified through the content database 460. Furthermore, when the output module 590 requests the reading of reference information 463 for second subject content 411, the reference information providing module 573 may provide, to the output module 590, second execution content 429 corresponding to the second subject content 411 which is identified through the content database 460.

The reference information providing module 573 may determine or create at least a portion of execution content 429 to be provided to the output module 590 as the target content 447. The reference information providing module 573 may determine the target content 447 based on information on a reader who identifies (e.g., receives, reads, or executes) the subject content 411 (e.g., based on reader information acquired through the output module 590). Additional information on the writer information will be described below together with the description of the output module 590.

For example, the reference information providing module 573 may determine the first execution content 429 as the target content 447 when the writer information is the first reader information and the second execution content 429 as the target content 447 when the writer information is the second reader information. The reader information may include, for example, the same or a similar type of information as the writer information.

The reference information providing module 573 may determine target content 447 corresponding to reader information using additional information (e.g., writer information, content information, activity information, or surrounding information). For example, the reference information providing module 573 may identify first writer information for the first execution content 429 and second writer information for the second execution content 429, as the additional information. When the first writer information corresponds to the reader information and the second writer information does not correspond to the reader information, the reference information providing module 573 may determine the first execution content 429 corresponding to the first writer information as target content 447.

For example, as additional information, content information for the first execution content 429 may be a “web site,” and content information for the second execution content 429 may be a “text document.” When a reader's preferred content information is a “web site,” the reference information providing module 573 may determine the first execution content 429 corresponding to the reader information as target content 447 by referring to additional information. For example, as additional information, if an expert level of the first execution content 429 is “low”, and the expert level of the second execution content is “high”, when the reader's expert level is “high,” the reference information providing module 573 may determine the second execution content 429 corresponding to the reader information as target content 447.

For example, the reader information may include information on a field of interest corresponding to the reader, if the field information for the first execution content 429 is “design,” and the field information for the second execution content 429 is “hardware”, then when the reader's field of interest is “design”, the reference information providing module 573 may determine the first execution content 429 corresponding to the reader information as target content 447.

For example, the additional information may include activity information on one or more pieces of execution content 429. If the activity information for the first execution content 429 is “reading,” and the activity information for the second execution content 429 is “highlight display”, then when the preferred activity designated to the reader information is “highlight display,” the reference information providing module 573 may determine the first execution content 429 corresponding to the reader information as target content 447.

For example, the additional information may include surrounding environmental information of the electronic device 101 for the execution time of execution content 429. If the surrounding environmental information for the first execution content 429 is a first temperature (e.g., about 10° C.), and the surrounding information for the second execution content 429 is a second temperature (about 25° C.), then when the preferred temperature (e.g., about 11° C.) designated to the reader information is closer to the first temperature, the reference information providing module 573 may determine the first execution content 429 corresponding to the reader information as target content 447.

For example, the additional information may include a writers emotional information when execution content is executed. Emotional information for the first execution content 429 may be first emotional information (e.g., “pleasant”), and emotional information for the second execution content 429 may be second emotional information (e.g., “grief”). When it is determined that a reader's emotion corresponds to the first emotional information based on information on the reader, the reference information providing module 573 may determine the first execution content 429 as target content 447. Further, when it is determined that the reader's emotion corresponds to the second emotional information based on the information on the reader, the reference information providing module 573 may determine the second execution content 429 as target content 447.

The reference information providing module 573 may determine target content 447 that corresponds to writer information among one or more pieces of execution content 429 by using additional information (e.g., writer information or surrounding information). For example, the additional information may include emotional information when a writer executes execution content 429. Emotional information for the first execution content 429 may be first emotional information (e.g., “pleasant”), and emotional information for the second execution content 429 may be second emotional information (e.g., “grief”). In cases where the first emotional information has a higher priority than the second emotional information, the reference information providing module 573 may determine the first execution content 429, which corresponds to the emotional information with a higher priority, as target content 447.

The reference information providing module 573 may determine target content 447 based on settings of a writer or reader or the electronic device 101 or the output module 590.

For example, if based on an input of a writer having created or edited subject content 411, the first execution content 429 is stored as target content 447 for a first reader while being grouped together with the first reader, and the second execution content is stored as target content 447 for a second reader while being grouped together with the second reader, the reference information providing module 573 may determine the first execution content 429 as target content 447 when a reader is identified to be the first reader and the second execution content 429 as target content 447 when the reader is identified to be the second reader.

The reference information providing module 573 may additionally determine target content 447 from one or more pieces of execution content 429 based on at least one of the attributes including the type, visual information, and auditory information of a providable content designated to the output module 590 or the content output device 480 to provide target content 447.

For example, when the type of the providable content designated to the output module 590 is a “web site” (e.g., when the output module 590 can output only the “web site”), the reference information providing module 573 may determine only the execution content 429 corresponding to the “web site”, from among one or more pieces of execution content 429, as target content.

The reference information providing module 573 also searches for new content (hereinafter, “search content”) different from execution content 429 based on a reader's information. For example, when there is no information suitable for the reader in execution content 429 stored in relation to subject content 411, the reference information providing module 573 searches for search content corresponding to the reader through the electronic device 101 or an external device (e.g., a cloud server).

The search content may be content for assisting a plurality of readers in reading a particular subject content 411. For example, if execution content 429 or target content 447 corresponding to subject content 411 requested by a reader is a magazine for “health care”, and the specialty level of the magazine is “high,” and the reader's level of knowledge is “low”, when the magazine is provided to the reader as is, the reader may not understand the magazine. In this case, the reference information providing module 573 may search for a web site including additional information (e.g., less professional information) for the reader whose specialty level is “low.”

The reference information providing module 573 may additionally store or update at least some information of the web site, which is the search content, as reference information 463 of the subject content 411. The reference information providing module 573 may re-designate the search content, which is additional reference information 463 for the subject content 411, as target content 447 to be provided to the reader.

For convenience of description, the target content 447 has been described as one execution content 429. However, the target content 447 may be a set of content including a plurality of pieces of execution content 429.

For example, reference information 463 for target content 447 corresponding to a reader may be a set of content including information on a plurality of pieces of execution content 429. For example, the target content 447 corresponding to a first reader may be a first set of content including first and second execution content 429 among the first to third execution content 429. Furthermore, the target content 447 corresponding to a second reader may be a second set of content including the second and third execution content 529.

The reference information providing module 573 may acquire or identify target content 447 through the content database 460 in which the target content 447 is stored or through another database.

For example, when only some content of the target content 447 are stored as reference information 463 for subject content 411, the reference information providing module 573 may identify the whole content of the target content 447 using some content.

For example, when only identification information of the target content 447 is stored, the reference information providing module 573 may identify the target content 447 acquired using the identification information.

For example, when at least some attributes of the target content 447 are modified and stored, the reference information providing module 573 may acquire the target content 447 by changing the attributes to other attributes.

Furthermore, when at least a portion of the target content 447 is compressed and stored, the reference information providing module 573 may acquire the target content 447 by decompressing the compressed target content 447.

The reference information providing module 573 may modify at least a portion (e.g., at least some formats or attributes) of the target content 447 to provide the same to the output module 590.

For example, the reference information providing module 573 may modify the target content 447 based on reader information. The reference information providing module 573, for example, may determine or modify visual information, auditory information, or attributes of the target content 447 based on preferred visual information, preferred auditory information, or preferred content attributes included in the reader information.

For example, when the reader information is first reader information, the reference information providing module 573 may determine the visual information, the auditory information, or the attributes of the target content 447 to be a first format. In contrast, when the reader information is second reader information, the reference information providing module 573 may determine the visual information, the auditory information, or the attributes of the target content 447 to be a second format.

For example, if the target content 447 is a text document for may function of a smart watch, when a preferred color, as the preferred visual information, is set to “blue” in the reader information, the reference information providing module 573 may change the text color of the text document to blue.

For example, if the target content 447 may be advertising music of a smart watch, when a preferred sound level, as the preferred auditory information, is set to “intermediate” in the reader information, the reference information providing module 573 may change the sound level of the advertising music to “intermediate.”

For example, if the target content 447 may include a web page for “design” of the smart watch and a circuit for “hardware” of the smart watch, when the first field of interest is set to “design” and the second field of interest is set to “hardware” in the reader information, the reference information providing module 573 may determine an area of a display where first information corresponding to a web page for “design,” which is the first field of interest, is to be displayed as a first area (e.g., the central portion of the display). In contrast, the reference information providing module 573 may determine an area of the display where second information corresponding to a document for “hardware,” which is the second field of interest, is to be displayed as a second area on the lower (or right) side of the first area.

For example, if a first data format of a video, which is target content 447, is different from (e.g., is not compatible with) a second data format set in the reader information, the reference information providing module 573 may change the data format of the video to the second data format.

For example, if the resolution of an image, which is target content 447, is a first resolution (e.g., 800×600) and the resolution set in the reader information is a second resolution (e.g., 1700×1300), the reference information providing module 573 may change the resolution of the image to the second resolution.

The reference information providing module 573 may change or determine at least a portion (e.g., a format or attribute) of the target content 447 based on the type, visual information, auditory information, or attribute of a providable content designated to the output module 590 or the content output device 480 to which the target content 447 is to be provided.

For example, when the output module 590 can output only a designated format, the reference information providing module 573 may change the target content 447 to the designated format.

For example, if the output module 590 only supports a black and white output, when an image, which is target content 447, is an image including colors other than black and white, the reference information providing module 573 may modify the color of the image to black and white.

For example, if the output module 590 may support a resolution of high quality, when the resolution of a text document, which is target content 447, is set to a resolution of low quality, the reference information providing module 573 may modify the resolution of the text document to a resolution of high quality.

The reference information providing module 573 may provide target content 447 to the output module 590, for example, without changing the target content 447.

The reference information providing module 573 may provide target content 447 connected to subject content 411 to the output module 590. For example, the target content 447 may be inserted into a partial area of the subject content 411 so that the target content 447 is provided in an area (e.g., in the interior of a speech bubble 485) associated with the subject content 411. In addition, the reference information providing module 573 may provide the subject content 411 first and then provide the target content 447 after a designated time (e.g., about 30 seconds).

The additional information providing module 575 may provide additional information corresponding to at least one of subject content 411 and target content 447 to the output module 590 in relation to the at least one piece of content. The additional information providing module 575 may identify additional information based on a request of the output module 590 for the additional information.

For example, when the output module 590 or the content providing device 480 makes a request for reading additional information on first target content 447 or first subject content 411, the additional information providing module 575 may identify first additional information corresponding to the first target content 447 or the first subject content 411 in the content database 460. Furthermore, when the output module 590 makes a request for reading additional information on second target content 447 or second subject content 411, the additional information providing module 575 may identify second additional information corresponding to the second target content 447 or the second subject content 411 in the content database 460.

For example, the additional information providing module 575 may provide, to the output module 590, a writer's feeling information which is additional information corresponding to subject content 411. In addition, the additional information providing module 575 may provide surrounding environmental information of the electronic device 101, which is additional information corresponding to target content 447, to the output module 590.

The additional information providing module 575 may provide the additional information in conjunction with the subject content 411 or the target content 447.

For example, when the additional information corresponding to the target content 447 is the writer's feeling information, the additional information providing module 575 may provide the feeling information in conjunction with the target content 447 (e.g., such that the feeling information is displayed in an adjacent area to the target content 447). Furthermore, when the additional information corresponding to the subject content 411 is temperature information, the additional information providing module 575 may provide the temperature information in conjunction with the subject content 411. Additional information on a method of providing subject content 411, reference information, and additional information will be described below in relation to FIGS. 7 to 9.

The output module 590 may provide or output subject content 411, target content 447, or additional information provided from the management module 550 to a reader based on the reader's input. To achieve this, the output module 590 may include a reader information acquisition module 591, a content request module 593, a content acquisition module 595, and a content output module 597.

The reader information acquisition module 591 may acquire reader information of a reader who reads subject content 411. For example, the reader information acquisition module 591 may acquire the reader's fingerprint as the reader information. The reader information acquisition module 591 may additionally acquire the reader's name or ID as the reader information.

The reader information acquisition module 591 may acquire the reader information (e.g., the name, preferred content, a field of interest, specialty level, areal information, access authority to content, preferred visual information, preferred auditory information, or the age of the reader) by using or analyzing the reader's execution pattern (e.g., the type of content previously executed by the reader). For example, when the reader frequently searches a web site relevant to “fashion,” the reader information acquisition module 591 may determine the reader's field of interest, which is reader information, to be “fashion.”

When the reader frequently reads a communication-related thesis (or specialized information), the reader information acquisition module 591 may determine the reader's specialty level, which is reader information, to be “high level” (e.g., expert level).

When the reader magnifies a font size included in content (e.g., about one and half times) to use the content, the reader information acquisition module 591 may determine the reader's preferred visual information, which is reader information, to be a large character (e.g., a character magnified about one and half times).

The content request module 593 may request at least one of subject content 411, target content 447, and additional information from the management module 550. The content request module 593 may request the subject content 411, the target content 447, or the additional information which corresponds to reader information acquired through the reader information acquisition module 591.

For example, in order to acquire the subject content 411, the target content 447, or the additional information corresponding to the reader information, the content request module 593 may provide (e.g., transmit) the reader information to the management module 550 when (or alternatively, before or after) requesting the subject content 411, the target content 447, or the additional information.

The content request module 593 may request at least one of the subject content 411, the target content 447, and the additional information from the management module 550 or the creation module 530 based on the reader's input. For example, the content request module 593 may request the subject content 411 from the management module 550 based on an input corresponding to the reading of the subject content 411 (e.g., a double click on an icon corresponding to the subject content 411).

For example, when the subject content 411 is displayed through a display functionally connected to the output module 590, the content request module 593 may acquire an input corresponding to the request of target content 447 for the subject content 411 (e.g., a click on a partial area of the subject content 411). Accordingly, the content request module 593 may request the target content 447 for the subject content 411 from the management module 550 based on the input.

For example, when the target content 447 is displayed through the display, the content request module 593 may acquire an input corresponding to the request of additional information for the target content 447 (e.g., a click on a partial area of the target content 447). Accordingly, the content request module 593 may request the additional information for the target content 447 from the management module 550.

The content acquisition module 595 may acquire from the management module 550, at least one of subject content 411, target content 447, and additional information which corresponds to a request of the content request module 593.

For example, the content acquisition module 595 may acquire the subject content 411 first and then acquire the target content 447 (or the additional information) according to a reader's request. In addition, the content acquisition module 595 may simultaneously acquire the subject content 411, the target content 447, and the additional information.

The content output module 597 may output at least one of subject content 411, target content 447, and additional information through the display 170 functionally connected to the content output module 597. For example, the content output module 597 may output the subject content 411 first and then may output the target content 447 or the additional information next. In addition, the content output module 597 may simultaneously output at least some of the subject content 411, the target content 447, and the additional information.

The content output module 597 may output the target content 447 or additional information related to the subject content 411 based on the fact that the providing module 570 may provide the target content 447 or the additional information related to the subject content 411. In addition, the content output module 597 may output the additional information related to the subject content 411 or the target content 447 based on the fact that the providing module 570 may provide the additional information related to the subject content 411 or target content 447.

The content output module 597 may display the target content 447 in an adjacent area to the area where the subject content 411 is displayed such that the target content 447 visually corresponds to the subject content 411. Alternatively, the content output module 597 may provide the target content 447 together with visual information (e.g., the speech bubble image 485 or a connection line) which may connect the target content 447 and the subject content 411. For example, the content output module 597 may successively provide the subject content 411 and the target content 447 (e.g., may provide the target content 447 immediately after the subject content 411). Additional information on a method of providing subject content 411, target content 447, or additional information will be described below in relation to FIGS. 7 to 9.

FIG. 6 illustrates an information storage structure, according to an embodiment of the present disclosure.

Referring to FIG. 6, an information storage structure 600 is provided. The information storage structure 600 is a structure in which subject content 610, execution content 633, 635, 637, and 639 designated as reference information 630 for the subject content 610, and additional information 670 are interconnected and stored in a memory (e.g., the memory 140 or the database 460) functionally connected to an electronic device 101.

For example, a document 611 is stored as the subject content 610, and the blog 633, the web site 635, the thesis 637, and the image 639, as the execution content, are stored as the reference information 630 of the subject content 610. The additional information 670 may include first additional information 671, second additional information 673, third additional information 675, fourth additional information 675, fifth additional information 677, and sixth additional information 679. The additional information contains, for example, users, fields, security levels, or specialties for each the document 611, the blog 633, the web site 635, the thesis 637, and the image 639.

The execution content 633, 635, 637, and 639 may be stored together with indices showing hierarchy information for the subject content 610. Accordingly, the information storage structure 600 may provide the correlation between the execution content 633, 635, 637, and 639 and the subject content 610 (e.g., information on a degree to which the execution content is associated with the subject content). For example, the execution content 633, 635, 637, and 639 with indices showing a hierarchy structure including one or more levels may be stored as the reference information 630.

The information storage structure 600 may show the hierarchy of the execution content 633, 635, 637, and 639 for the subject content 610 in various manners using characters, character strings, numbers, figures, images, or the like.

The primary level which is the highest level among the reference information 630 may be indexed (e.g., designated or stored) through an alphabetic character (e.g., A, B, or C). The secondary level which is one step lower than the highest level may be indexed by adding a number to the alphabetical character. For example, the second execution content having the secondary level which is one step lower than the first execution content classified into A of the primary level may be stored with an index “A-1.”

One or more writers may create or edit the document 611, which is the subject content 610, using the various pieces of execution content including the blog 633, the web site 635, and the image 639. In this case, at least some information for the document 611 (e.g., the document title) may be stored as the subject content 610. Furthermore, the blog 633, the web site 635, and the image 639 may be stored as the reference information 630 for the document 611. For example, a first writer may read the blog 633 while creating the document 611, and a second writer may identify the image 639 while editing the document 611 created by the first writer. In this case, the blog 633 and the image 639 executed by the first and second writers who have directly created or edited the document 611 may be stored as the reference information 630 for the document 611.

The blog 633 or the image 639, for example, may be execution content which the first or second writer has primarily (e.g., most preferentially) referred to when creating or editing the document 611. For example, the blog 633 or the image 639 may be execution content which the first or second writer has executed first, has most widely used, or has read for the longest time. Accordingly, in this case, the blog 633 or the image 639 may be stored as the reference information 630 having the primary level (e.g., higher level) of the subject content 610. For example, the blog 633 referred to by the first writer may be designated as “A. Blog” at the primary level which is the highest level. Although belonging to the same hierarchy as the blog 633, the image 639 referred to by the second writer, for example, may be designated as “B. Image” which is a different classification from the blog 633 in terms of the writer or the type thereof.

The first writer may search for the web site 635 which is the second execution content relating to the blog 633 while referring to the Wog 633 as the first execution content. For example, although the blog 633 may provide contents relating to hardware, the first writer may have difficulty understanding the same due to the specialty level of “intermediate.” In this case, the first writer may search for the web site 635 that is provided by a first server, has the specialty level of “low”, and may include contents of hardware. In this case, the web site 635 may be execution content that the first writer has referred to secondarily (e.g., less preferentially than the primary execution content) when creating the document 611. For example, the web site 635 may be content to which the first writer has merely referred to in order to understand the contents of the blog 633 having the primary level, or may be content that has been executed after the blog 633 which is the first execution content, or content that has been less cited than the contents of the blog 633. Accordingly, the web site 635 may be stored as the reference information 630 having the secondary level (e.g., intermediate level) of the document 611. For example, based on the blog 633 referred to by the first writer, the executed web site 635 may be designated as “A-1. Web site” at the secondary level in relation to the blog 633.

The thesis 637 may be content (e.g., search content) designated as the reference information 630 of the document 611 through an additional search based on information on a reader who reads the document 611 which is the subject content 610. For example, if a reader, having a specialty level for hardware of “low” and a security level of “low”, reads the document 611, since the web site 635, which is designated as reference information 630 for the document 611, having a specialty level for hardware of “low”, has the security level of “high”, the reader will not be able to read the web site.

In this case, the thesis 637, having a specialty level for hardware of “low” and a lower security level at which the reader may read the same, may be additionally searched for through a second server and provided to the reader. In this case, the thesis 637 may be designated as “A-1-1. Thesis” in relation to the blog 633 and the web site 635, as the reference information 630 having a tertiary level which is connected to the web site 635 at the secondary level.

The additional information 670 may be stored to be associated with the subject content 610 or the execution content 633, 635, 637, and 639 (e.g., as metadata of the subject content 610 or the execution content 633, 635, 637, and 639).

For example, additional information 670 may be stored about the document 611 indicating that the writer of the document 611 may be the first and second writers, the content of the document 611 may be “smart watch function,” and the security level of the document 611 may be “low.” In this case, first additional information 671 for the document 611 may include, information “Writer: first writer and second writer,” “Field: smart watch function,” and “Security level: low.”

For example, additional information 670 may be stored about the blog 633 indicating that the executor of the blog 633 is the first writer, the content of the blog 633 may be “hardware”, the specialty level of the blog 633 is “intermediate”, and the security level of the blog 633 “low.” in this case, second additional information 673 for the blog 633 may include information “Executor: first writer,” “Field: hardware,” “Specialty: intermediate,” and “Security level: low.”

For example, additional information 670 may be stored about the web site 635 indicating that the executor of the web site 635 may be the first writer, the device used to create the web site 635 may be the “first server”, the content of the website 635 is “hardware,” the specialty level of the web site 635 may be “low,” and the security level of the web site 635 may be “high.” in this case, third additional information 675 for the web site 635 may include information “Executor: first writer,” “Creation device: first server,” “Field: hardware,” “Specialty: low,” and “Security level: high.”

For example, additional information 670 may be stored about the thesis 637 indicating that the executor of the thesis 637 may be the reader, the device used to create the thesis 637 may be the “second server”, the content of the thesis 637 may be “hardware,” the specialty level of the thesis 637 may be “low,” and the security level of the thesis 637 may be “low.” In this case, fourth additional information 677 for the thesis 637 may include information “Executor: reader,” “Creation device: second server,” “Field: hardware,” “Specialty: low,” and “Security level: low.”

For example, additional information 670 may be stored about the image 679 indicating that the writer of the image 639 may be the second writer, and the content of the image may be “design,” In this case, fifth additional information 679 for the image 639 may include information “Writer: second writer,” and “Field: design.”

The information storage structure 600 illustrated in FIG. 6 is merely an example, and various embodiments of the present disclosure may include a variety of information storage structures without being limited thereto.

FIG. 7A illustrates a user interface for providing content, according to an embodiment of the present disclosure.

Referring to FIG. 7A, a user inter by which an electronic device provides arbitrary content or execution content (e.g., the execution content 429) through a display (e.g., the display 170), according to various embodiments of the present disclosure is provided. The content 702 that contains subject content 701 (e.g., the subject content 411), which is being created (or before or after completion), may be provided to a writer through a display 700. The writer may execute first arbitrary content (e.g., the first content 421) and second arbitrary content (e.g., the second content 423) in order to refer to the first and second arbitrary content while (or before or after) creating the subject content 701. In this case, the first and second arbitrary content may be determined to be execution content for the subject content 701. A first object 703 that corresponds to the first arbitrary content and a second object 704 that corresponds to the second arbitrary content may be provided (e.g., displayed) through the display 700 in relation to the subject content 701. For example, the first and second objects 703 and 704 may be displayed so as to overlap with the subject content 701.

The first object 703 may include, for example, at least a part of first execution content or an icon, an image, a video, or a text that corresponds to the first execution content. Further, the second object 704 may include, for example, at least a part of second execution content or an icon, an image, a video, or a text that corresponds to the second execution content.

According to an embodiment, the writer may execute third arbitrary content 706 (e.g., the third content 425) in order to refer to the third arbitrary content while (or before or after) creating the subject content 701. The third arbitrary content 706 may be provided through the display 700. In this case, the third arbitrary content 706 may be determined to be execution content for the subject content 701. According to an embodiment, in cases where an event for the third arbitrary content 706 occurs (e.g., the execution of the third arbitrary content 706 is at least temporarily stopped), a third object 708 or 709 that corresponds to the third arbitrary content 706 may be provided through the display 700. For example, in cases where the event for the third arbitrary content 706 occurs, an animation in which the third arbitrary content 706 is reduced to the object 708 having a first size, and the object 708 which is reduced to the object 709 having a second size, may be displayed through the display 700.

The third object 709 may be, for example, content obtained by changing the size or shape of the third arbitrary content 706 (e.g., content to which the third arbitrary content 706 is reduced in size). The third object 709 may include, for example, an icon, an image, a video, or a text that corresponds to the third arbitrary content 706. For example, the third object 708 may have the same or a similar size or shape to the first or second object 703 or 704. According to an embodiment, although not illustrated, the first, second, or third object 703, 704, or 709 may be provided based on a user input for the subject content 701 that is being created (or, before or after completion) (e.g., a touch input, a force touch input, or a hovering input on the area where the subject content 701 is displayed).

According to an embodiment, based on the writer's input that corresponds to the first, second, or third object 703, 704, or 709, at least one of the first to third arbitrary content 706 may be excluded from the execution content for the subject content 701. For example, the first arbitrary content may be excluded from the execution content for the subject content 701 in cases where the writer's input for the first object 703 is acquired. Accordingly, only the second and third objects 703, 708 that correspond to the second and third arbitrary content 706, respectively, which are the execution content for the subject content 701, may be displayed.

According to an embodiment, fourth arbitrary content may be added as execution content based on the writer's input. For example, in cases where the fourth arbitrary content is executed in the electronic device, the fourth arbitrary content may be determined to be execution content for the subject content 701 on the basis of a user input for the fourth arbitrary content. Accordingly, a fourth object that corresponds to the fourth arbitrary content may be displayed in relation to the subject content 701.

FIG. 7B illustrates a user interface for providing content, according to an embodiment of the present disclosure.

Referring to FIG. 7B, a user interface by which an electronic device provides subject content, execution content, or additional information to a writer through a display (e.g., the display 170), according to various embodiments of the present disclosure is provided. The subject content 734 may be provided through a display 730. The writer may execute arbitrary content 736 using the electronic device in order to refer to the arbitrary content while (or before or after) creating the subject content 734 in content 732. In this case, the arbitrary content 736 may be provided through the display 730.

According to an embodiment, in cases where an object 738 associated with additional information (e.g., writer information) is included in the arbitrary content 736, additional information 740 and 742 (or objects that represent the additional information) may be provided through the display 730.

The writer may create mail 736 (e.g., arbitrary content) while (or before or after) creating the subject content 734 through the electronic device. Accordingly, the mail 736 may be provided (e.g., displayed) through the display 730 that is functionally connected to the electronic device (e.g., the display 730 that is included in the electronic device, or connected to the electronic device through wired or wireless communication). The electronic device may acquire the writer's emotional information as additional information. For example, the electronic device may determine the writer's emotional information based on the object 738 (e.g., “successfully”) that the writer enters into the mail 736.

Referring to FIG. 7B, the electronic device may determine the writer's emotional information to be “pleasant” based on the first object 738 “successfully” that the writer enters into the mail 736. Accordingly, the additional information 740, 742 that corresponds to “pleasant” may be provided through the display 730. For example, the additional information 740, 742 may be provided as an animation in which the object 740 having a first size is changed into the object 742 having a second size (e.g., larger than the first size). The additional information 740, 742 may include, for example, an icon, an image, a video, or a text that corresponds to the writer's emotional information.

The additional information (e.g., emotional information) may be determined based on a sensor (e.g., a brain-wave sensor or a heart rate sensor) or an input pattern (e.g., a text input pattern) of the writer. According to an embodiment, additional information (e.g., emotional information) for the arbitrary content 736 may be identified in response to a specified input (e.g., a force touch input) for the arbitrary content 736. For example, the electronic device may identify the writer's emotional information in response to a first input (e.g., a force touch or a long press) on the area where the arbitrary content 736 is displayed. Further, in response to a second input (e.g., a touch or a hovering input) on the area where the arbitrary content 736 is displayed, the electronic device may not identify the writer's emotional information, but may execute a different function (e.g., a selection of text) that corresponds to the second input.

FIG. 7C illustrates a user interface for providing content, according to an embodiment of the present disclosure.

Referring to FIG. 7C a user interface through which an electronic device may provide subject content (e.g., the subject content 411) or target content (e.g., the target content 447) as reference information through a display (e.g., the display 170). The first content 713 including first subject content 721 may be provided to a first reader 711 through a first display 710. Furthermore, when the first reader 711 makes a touch (or a hovering input, a force touch, or long press), as a first input 717, on an area where the first subject content 721 is displayed (or an object that corresponds to the first subject content 721), first target content 723 may be provided as reference information for the first subject content 721 through the first display 710.

A method of providing the first target content may be determined based on the type of the first input 717. For example, in cases where the first reader 711 makes a hovering input (or a touch), as the first input 717, on the area where the first subject content 721 is displayed, at least a part of the first target content 723 may be provided as reference information for the first subject content 721 through the first display 710 for a specified time (e.g., about 10 seconds). For example, in cases where the first reader 711 makes a force touch (e.g., a press stronger than the touch), as the first input 717, on the area where the first subject content 721 is displayed, the first target content 723, which is reference information for the first subject content 721, may be executed.

The first target content 723 may be provided in a designated format (e.g., size or shape) to the first reader 711. For example, if the first reader 711 does not have good eyesight, the first target content 723 may be provided to be larger than second target content 763 that is provided to a second reader 751 having better eyesight. For example, the first target content 723 may be provided to be larger than configured in the first display 710. The first target content 723 may be provided in a shape having a lateral length larger than the longitudinal length thereof, as a shape designated to the first reader 711.

The first target content 723 may be provided at a location adjacent to the first subject content 721. For example, the first target content 723 may be provided through a second output window 729 (e.g., popup window) different from a first output window 719 in which the first subject content 721 is provided. An attribute (e.g., location, size, or shape) of the first output window 719 may be modified based on an input of the first reader 711.

The second content 753, including second subject content 761, may be provided to the second reader 751 through a second display 710. Furthermore, a selection menu 755 may be provided through the second display 750 based on a second input of the second reader 751 (e.g., a touch on the area where the second subject content 761 is output). The selection menu 755, for example, may represent a user interface for selecting whether to search for execution content as reference information for the second subject content 761.

When the second reader 751 makes a selection to search for the execution content for the second subject content 761 through the selection menu 755 as indicated by reference numeral 757, the second target content 763 corresponding to the second reader 751 may be provided through the second display 750. The second target content 765 may be provided in a format designated according to the second reader 751. For example, when the second reader 751 prefers a relatively small user interface, the second target content 763 may be provided in a second size smaller than a first size set for the second display 750. The second target content 763 may be provided in a shape that the second reader 751 prefers (e.g., a shape having a longitudinal length larger than the lateral length thereof).

The second target content 763 may be provided through a second area 769 different from a first area 759 where the second subject content 761 is provided. The first and second areas 759 and 769 may be separate from each other. For example, the second target content 763 may be provided at a location relating to the location where the second subject content 761 is provided through the second display 750 (e.g., on the right side of the second subject content 761). The second target content 763 may be provided while being connected to the subject content 761 through a connection line 771. The first and second areas 759 and 769 may at least partially overlap each other.

The third content 773 that includes a third subject content 781 may be provided to a third reader 771 through a third display 770. Further, first or second additional information 775 or 777, which corresponds to at least one piece of content that the writer has referred to while creating the third subject content 781, may be provided to the third reader 771. Based on a third input 779 (e.g., a touch on the area where the first or second additional information 775 or 777 is output) of the third reader 771, third content 783 that corresponds to the third input 779 among one or more pieces of target content may be provided as reference information for the third subject content 781 through the third display 770.

In cases where the third reader 771 makes the touch 779 on the area where the second additional information 777 is output, the third target content 783, which corresponds to the second additional information 777 (e.g., “grief”) (for example, which is stored in connection with the second additional information 777) among one or more pieces of content for the third subject content 781, may be provided through the third display 770. Further, in cases where the third reader 771 makes a touch on the area where the first additional information 775 is output, another piece of target content that corresponds to the first additional information 775 (e.g., “pleasant”) among one or more pieces of target content for the third subject content 781 may be provided through the third display 770.

According to an embodiment, a method of displaying the third target content 783 or the other piece of target content may be determined based on a method in which the third reader 771 enters the third input 779 on the first or second additional information 775 or 777. For example, in cases where the third reader 771 makes a touch or a hovering input on the area where the second additional information 777 is output, the third target content 783 may be displayed for a specified time (e.g., temporarily). Further, in cases where the third reader 771 makes a force touch or a long press on the area where the second additional information 777 is output, the third target content 783 may be continually (e.g., for a longer period of time than a specified time) displayed or executed in at least one area.

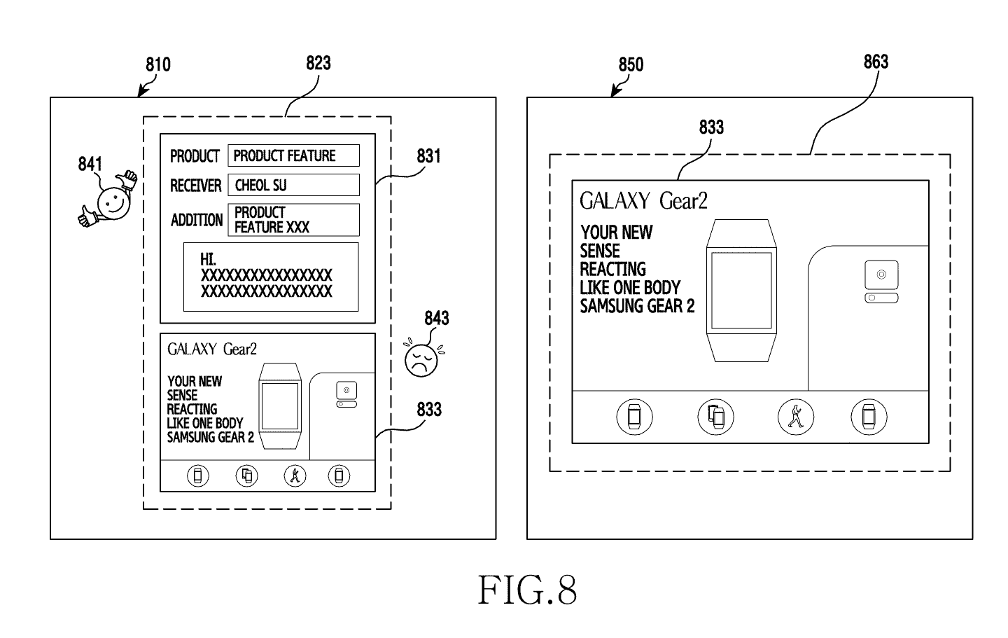

FIG. 8 illustrates a user interface for providing content, according to an embodiment of the present disclosure.

Referring to FIG. 8, a user interface through which an electronic device may provide target content or additional information through a display is provided. For example, first target content 823 designated to the first reader 711 may be provided separately from the first subject content 721 to the first reader 711, through a first display 810.

For example, the first subject content 721 may be provided before providing the first target content 823 through the first display 810. The first reader, for example, may request the first target content 823 for the first subject content from the management module 550. In this case, the subject content may no longer be provided through the first display 810, and the first target content 823 may be provided through the first display 810.

The first target content 823 may include one or more pieces of execution content designated to the first reader 711 (e.g., a set including one or more pieces of execution content corresponding to the first reader). For example, if the first reader 711 may have access authority to first execution content 831 and second execution content 833, when the first reader requests target content, the first target content 823 including the first execution content 831 and the second execution content 833 may be displayed as reference information to the first reader 711 through the first display 810.

The first execution content 831 and second execution content 833 may be differently provided based on content preferred by a reader. For example, the first reader may prefer the first execution content 831 to the second execution content 833. Accordingly, the first execution content 831 may be displayed on the upper side of the area of the first display 810 where the second execution content 833 is displayed.

Additional information associated with the first target content 823 may include first additional information 841 and second additional information 843. The first additional information 841 is associated with the first execution content 831 and may represent emotional information, such as “pleasant”, that a writer of subject content feels while referring to the first execution content 831.

The second additional information 843 is associated with the second execution content 833 and may represent emotional information, such as “grief”, that the writer of the subject content feels while referring to the second execution content 833.

The first additional information 841 may be provided through an area close to the area of the first display 810 where the first execution content 831 is provided (e.g., through the left side of the first execution content 831). The second additional information 843 may be provided through an area close to the area of the first display 810 where the second execution content 833 is provided (e.g., through the right side of the second execution content 833).

In cases where a reader's input that corresponds to the first or second additional information 841 or 843 displayed on the display 810 is acquired, the reader's additional information (e.g., emotional information) may be input. For example, in cases where the reader makes a touch (or, a hovering input, a force touch, or a long press) on the area of the first display 810 where the first additional information 841 is displayed, a user interface by which the reader's emotional information may be input may be provided through the first display 810. Further, in cases where the reader makes a touch (or, a hovering input, a force touch, or a long press) on the area of the first display 810 where the first additional information 841 is displayed, the electronic device may, for example, automatically acquire the reader's emotional information.

In cases where the reader's input (e.g., a touch, a force touch, a hovering input, or a long press) that corresponds to the first or second additional information 841 or 843 displayed on the first display 810 is acquired, at least one piece of execution content associated with the additional information 841 or 843 that corresponds to the input may be provided. For example, in cases where the reader makes a force touch on the area of the first display 810 that corresponds to the first additional information 841 relevant to “pleasant,” another piece of execution content in which the writer has felt “pleasant” when executing it may be provided through the first display 810. Further, in cases where the reader makes a force touch on the area of the first display 810 that corresponds to the second additional information 843 relevant to “grief,” another piece of execution content in which the writer has felt “grief” when executing it may be provided through the first display 810.

The second target content 863 designated to the second reader 751 may be provided separately from the second subject content 761 to the second reader 751 through a second display 850. For example, the second subject content 761 may disappear from the second display 850 based on the fact that the second target content 863 is provided through the second display 850.

The second target content 863 may include only one piece of execution content to correspond to the second reader 751. For example, unlike the first reader 711, the second reader 751 may not have access authority to the first execution content 831 and may have only access authority to the second execution content 833. In this case, when the second reader 751 requests target content, only the second target content 863 corresponding to the second execution content 833 may be displayed to the second reader 751 through the second display 850. When the second reader 751 may prefer the second execution content 833 to the first execution content 831, the second target content 863, including only the second execution content 833, may be provided through the second display 850.

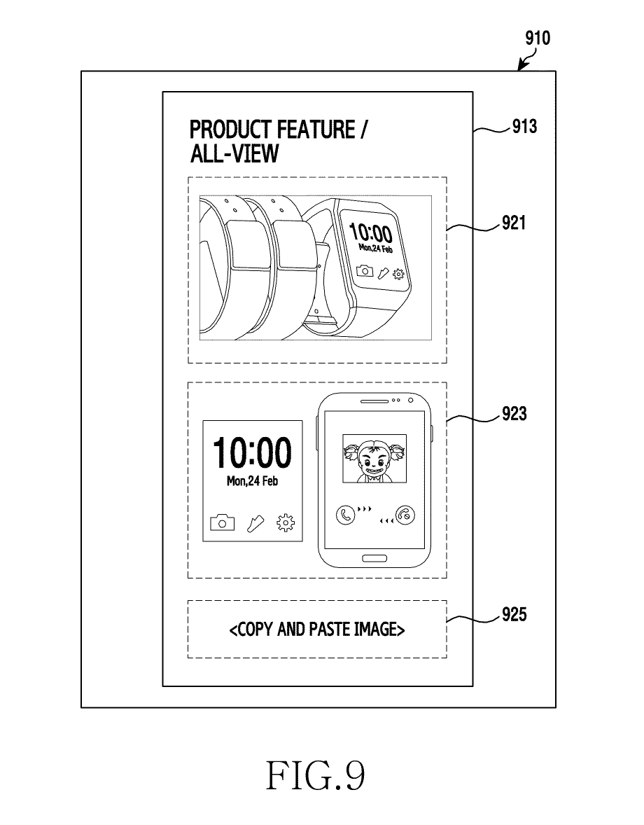

FIG. 9 illustrates a user interface for providing content, according to an embodiment of the present disclosure.

Referring to FIG. 9, a user interface by which an electronic device 101 may provide content through a display 170. The subject content 921, target content 923, and additional information 925 are provided as one piece of integrated content 913.

The subject content 921, the target content 923, and the additional information 925 may be provided through the display 910, in adjacent areas, while being associated with each other. For example, an image which corresponds to the target content 923 is displayed on the lower side of the area where the subject content 921 is displayed. In addition, the additional information 925 may be displayed on the lower side of the area where the target content 923 is displayed. The additional information 925 may be, for example, “copy and paste an image” as activity information for the target content 923.

The integrated content 913 is, for example, one image provided through one frame output on the display 910 for one clock. For example, the subject content 921, the target content 923, and the additional information 925 are not provided as separate frames having a time difference between them. Instead, they are output on the display 910 through one image data in which separate frames are composed with each other and provided in one frame.

According to various embodiments, an electronic device (e.g., the electronic device 101) for managing reference information (e.g., the reference information 463) for provided content (e.g., the subject content 411) may include: a memory for storing reference information executed in relation to the creation or editing of content (e.g., the subject content 411); and a processor 130 (e.g., the content management module 510), wherein the processor is set to provide the content (e.g., the subject content 411) through a display functionally connected to the processor and provide at least some (e.g., the target content 447) of the reference information in relation to the content.

According to various embodiments, the reference information may include at least a portion of another piece of content (e.g., the execution content 429) previously executed in relation to the content.

According to various embodiments, the reference information may include another piece of content (e.g., the execution content 429) provided through at least one of a messenger, a message, a web editor, a browser, a document editor, a word processor, a spreadsheet, e-mail, a multimedia editor, a voice recorder, a camera, a telephone, a multimedia player, and a scheduler.

According to various embodiments, the processor 130 (e.g., the content management module 510) may receive the at least some reference information from an external device (e.g., the content creation device 410 or the content management device 440).

According to various embodiments, the processor 130 (e.g., the content management module 510) may identify a user (e.g., a reader) corresponding to the electronic device, provide a first set of the reference information as the at least some reference information when the user is a first user, and provide a second set of the reference information as the at least some reference information when the user is a second user.

According to various embodiments, the processor 130 (e.g., the content management module 510) may identify a profile (e.g., reader information) for a user identifying the subject content through the display, provide a first set of the reference information as the at least some reference information when the profile is a first profile, and provide a second set of the reference information as the at least some reference information when the profile is a second profile.

According to various embodiments, the processor 130 (e.g., the content management module 510) may determine the profile on the basis of the user's input.

According to various embodiments, the profile may include information on at least one of the user's interest, specialty, preference, and access authority for at least one of the content and the reference information.

According to various embodiments, the processor 130 (e.g., the content management module 510) may identify a user corresponding to the electronic device, provide the at least some reference information in a first format (e.g., in a first size) when the user is a first user, and provide the at least some reference information in a second format (e.g., in a second size) when the user is a second user.

According to various embodiments, the processor 130 (e.g., the content management module 510) may identify a preference of a user, corresponding to the electronic device, for information included in the at least some reference information, provide the information through a first area of the display when the preference is a first preference, and provide the information through a second area of the display (an area on the lower side of the first area) when the preference is a second preference (e.g., preference lower than the first preference).

According to various embodiments, the processor 130 (e.g., the content management module 510) may acquire a user input for selecting at least a portion of the content and provide the at least some reference information in response to the user input.

According to various embodiments, the content may include first content and second content, and the processor 130 (e.g., the content management module 510) may determine first reference information among the reference information as the at least some reference information when a user corresponding to the electronic device selects the first content and determine second reference information among the reference information as the at least some reference information when the user selects the second content.

According to various embodiments, the processor 130 (e.g., the content management module 510) may further provide additional information for the at least some reference information.

According to various embodiments, the at least some reference information may include first reference information and second reference information, and the additional information may include first additional information and second additional information, wherein the first additional may include information feeling information of a first user corresponding to the first reference information, and the second additional information may include feeling information of a second user corresponding to the second reference information.

According to various embodiments, the processor 130 (e.g., the content management module 510) may provide additional information associated with the reference information in relation to the content, and may select at least part of the reference information that corresponds to the additional information based on an input for the additional information.

According to various embodiments, an electronic device (e.g., the electronic device 101) for managing reference information (e.g., the reference information 463) for provided content (e.g., the subject content 411) may include a processor 130 (e.g., content management module 510), wherein the processor 130 (e.g., the content management module 510) may acquire first content (e.g., the subject content 411), identify second content (e.g., the execution content 429) executed in relation to the creation or editing of the first content, and designate the second content as reference information (e.g., the reference information 463) for the first content using at least one processor.

According to various embodiments, the processor 130 (e.g., the content management module 510) may acquire the first content from an external electronic device (e.g., the content creation device 410 or the content management device 440).

According to various embodiments, the processor 130 (e.g., the content management module 510) may determine the correlation between the second content and the first content, designate the second content as the reference information when the correlation is a first designated degree (e.g., high), and not designate the second content as the reference information when the correlation is a second designated degree (e.g., low).

According to various embodiments, the processor 130 (e.g., the content management module 510) may determine whether the second content includes the same content as the first content.

According to various embodiments, the processor 130 (e.g., the content management module 510) may determine whether the second content is simultaneously executed with the first content at least temporarily.

According to various embodiments, the processor 130 (e.g., the content management module 510) may determine whether an activity (e.g., paste) designated for the second content has occurred.

According to various embodiments, the first content may be created or edited by first and second users, and the second content may include a plurality of pieces of content executed by each of the first and second users.

According to various embodiments, the second content may include a plurality of pieces of content, and the plurality of pieces of content may be executed through different electronic devices.

According to various embodiments, the processor 130 (e.g., the content management module 510) may update the reference information on the basis of information on a user who wants to read the first content.

According to various embodiments, the processor 130 (e.g., the content management module 510) may identify whether information corresponding to the user information exists among the reference information and additionally search for third content corresponding to the user information on the basis of the second content when there is no information corresponding to the user information. The processor 130 (e.g., the content management module 510) may update the third content to reference information.

According to various embodiments, the processor 130 (e.g., the content management module 510) may store user activity information for the second content, a profile of a user corresponding to the electronic device, or external environment information for the electronic device.

According to various embodiments, the processor 130 (e.g., the content management module 510) may display the second content through a display that is functionally connected to the electronic device, may acquire user information for the electronic device based on at least a part of the second content, and may display an object, which corresponds to the user information, through the display in relation to the second content.

According to various embodiments, the processor 130 (e.g., the content management module 510) may display the first content through a display that is functionally connected to the electronic device and may display an object, which corresponds to the reference information, through the display in relation to the first content.

According to various embodiments, the processor 130 (e.g., the content management module 510) may identify a user corresponding to the electronic device, determine at least one of a set and a format of the reference information corresponding to the user, and provide the reference information in relation to the first content on the basis of the at least one of the set and the format.

According to various embodiments, the electronic device 101 for managing the reference information 463 for the subject content 411 may include a processor 130 (e.g., the content management module 510), wherein the processor may identify the subject content 411 provided through the electronic device 101 or an external electronic device (such as the first external electronic device 102, the second external electronic device 104, or the server 106) for the electronic device 101, may determine at least some reference information, i.e., the target content 447, to be provided in relation to the subject content 411 among reference information 463 (e.g., the execution content 429 designated as the reference information 463) executed in relation to the creation or editing of the subject content 411, and transmit the target content 447 to the external electronic device.

The processor 130 (e.g., the content management module 510) may identify a user (e.g., reader) for the external electronic device (e.g., a device for reading the content) and selects information accessible by the user among the reference information 463 as the at least some reference information, i.e. the target content 447.

The reference information 463 may include a first set and a second set of reference information. The processor 130 (e.g., the content management module 510) may identify a user for the external electronic device and select the first set of reference information as the at least some reference information 463 when the user is a first user, and select the second set as the at least some reference information 463 when the user is a second user.

The processor 130 (e.g., the content management module 510) may identify a user's profile for the external electronic device and determine a format to provide at least one of the at least some reference information 463 and additional information for the at least some reference information 463 based on the user's profile.

The format may include at least one of a color, a size, a shape, and graphics for at least a partial area of the at least some reference information 463.

The processor 130 (e.g., the content management module 510) may transmit the additional information to the external electronic device to provide the additional information for the at least some reference information 463, in relation to the subject content 411 or the at least some reference information 463, through the external electronic device.

The processor 130 (e.g., the content management module 510) may create another content including the original content and the at least some reference information 463 and transmit the other content to the external electronic device.

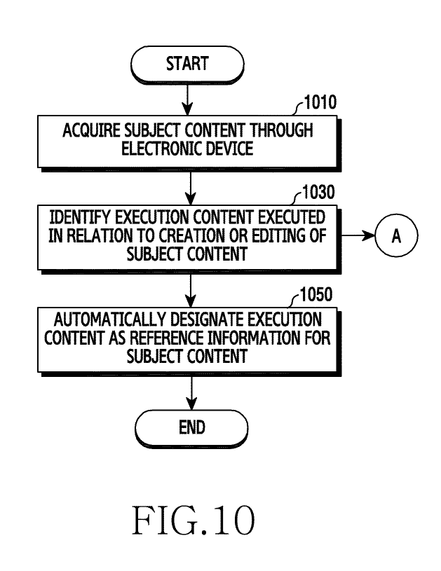

FIG. 10 is a flowchart illustrating a method for designating reference information in an electronic device, according to an embodiment of the present disclosure.

Referring to FIG. 10, in operation 1010, the management module 550 of electronic device 101 may acquire subject content 411 through the subject module 530 of the electronic device 101.

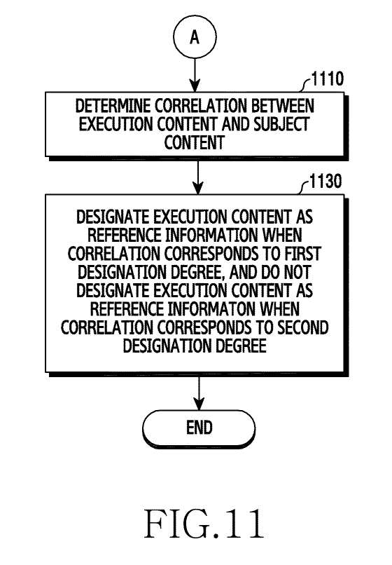

In operation 1030, the management module 550 of the electronic device 101 may identify execution content 429 executed in relation to the creation or editing of the subject content 411. Additional information for the operation 1030 will be described below in relation to FIG. 11.

In operation 1050, the management module 550 of the electronic device 101 may store the execution content 429 as reference information 463 for the subject content 411.

The above operations may be executed in one or more electronic devices. For example, operations 1010 and 1030 may be executed in the content creation device 410. The content creation device 410 may transmit the subject content 411 and the execution content 429 to the content management device 440. In this case, operation 1050 may be executed in the content management device 440.

FIG. 11 is a flowchart illustrating a method for identifying execution content, according to an embodiment of the present disclosure.

Referring to FIG. 11, in operation 1110, the management module 550 of an electronic device 101 may determine the correlation between the execution content 429 and subject content 411 (e.g., determines whether the correlation is “high” or “low”) in order to identify the execution content 429.

In operation 1130, the electronic device 101 may designate the execution content 429 as reference information 463 for the subject content 411 when the correlation corresponds to a first designation degree (e.g., high). In contrast, the electronic device 101 does not designate the execution content 429 as the reference information 463 for the subject content 411 when the correlation corresponds to a second designation degree (e.g., low).

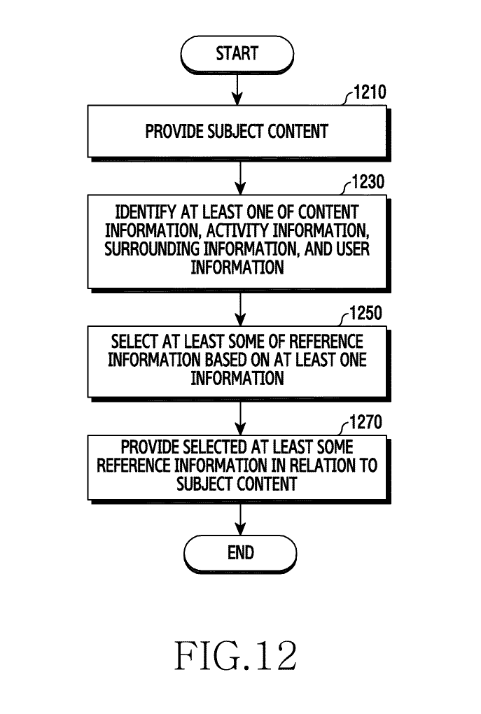

FIG. 12 is a flowchart illustrating a method for providing reference information in an electronic device, according to an embodiment of the present disclosure.

Referring to FIG. 12, in operation 1210, the management module 550 of electronic device 101 may provide subject content 411. In operation 1230, the electronic device 101 may identify at least one of content information, activity information, surrounding information, and user information. According to an embodiment, in operation 1230, in cases where another user has identified at least some of the reference information for the subject content, the electronic device may identify the other user's information (e.g., the other user's emotional information or evaluation information) for the reference information.

In operation 1250, the electronic device 101 may select at least some of the reference information 463, that is the target content 447, based on the at least one piece of content information. According to an embodiment, in operation 1250, the electronic device may select at least some of the reference information based on the other user's information for the subject content. For example, evaluation information when the other user has identified first reference information for the subject content may be first evaluation information (e.g., “best”), and evaluation information when the other user has identified second reference information for the subject content may be second evaluation information (e.g., “bad”). Accordingly, the electronic device may select the first reference information, which corresponds to the first evaluation information, as at least some reference information (e.g., the target content 447) to be provided to a user.

In operation 1270, the reference information providing module 573 or the content output module 597 of the electronic device 101 may provide the selected at least some reference information 463 related to the subject content 411.

According to an embodiment, some of the above operations may be modified or omitted. For example, operation 1230 may be omitted. In this case, the electronic device 101 may determine the at least some reference information 463 based on the settings designated to the electronic device 101 irrespective of the at least one piece of content information acquired in operation 1230.

According to various embodiments, a method of managing reference information (e.g., the reference information 463) for provided content (e.g., the subject content 411) may include: providing content through a display functionally connected to an electronic device (e.g., the content management module); and providing at least some of the reference information, which is executed in relation to the creation or editing of the content, in conjunction with the content.

According to various embodiments, the providing of the at least some reference information may include receiving the at least some reference information from an external device.

According to various embodiments, the providing of the at least some reference information may include: identifying a user corresponding to the electronic device; providing a first set of the reference information as the at least some reference information when the user is a first user; and providing a second set of the reference information as the at least some reference information when the user is a second user.

According to various embodiments, the providing of the at least some reference information may include: identifying a profile for a user who identifies the subject content through the display; providing a first set of the reference information as the at least some reference information when the profile is a first profile; and providing a second set of the reference information as the at least some reference information when the profile is a second profile.

According to various embodiments, the identifying of the profile may include determining the profile on the basis of an input of the user.

According to various embodiments, the providing of the at least some reference information may include: identifying a user corresponding to the electronic device; providing the at least some reference information in a first format when the user is a first user; and providing the at least some reference information in a second format when the user is a second user.

According to various embodiments, the providing of the at least some reference information may include: identifying a preference of a user corresponding to the electronic device for information included in the at least some reference information; providing the information through a first area of the display when the preference is a first preference; and providing the information through a second area of the display when the preference is a second preference.

According to various embodiments, the providing of the at least some reference information may include; acquiring a user input for selecting at least a portion of the content; and providing the at least some reference information in response to the user input.

According to various embodiments, the content may include first content and second content, and the providing of the at least some reference information may include: determining first reference information among the reference information as the at least some reference information when the user corresponding to the electronic device selects the first content; and determining second reference information among the reference information as the at least some reference information when the user corresponding to the electronic device selects the second content.

According to various embodiments, the method of managing reference information for provided content may further include providing additional information for the at least some reference information.

According to various embodiments, the method of managing reference information (e.g., the reference information 463) for provided content (e.g., the subject content 411) may further include providing additional information associated with the reference information in relation to the content and selecting the at least some reference information, which corresponds to the additional information, from the reference information based on an input for the additional information.

According to various embodiments, a method of managing reference information for provided content may include: acquiring first content in an electronic device; identifying second content executed in relation to the creation or editing of the first content; and designating the second content as reference information for the first content using at least one processor.

According to various embodiments, the acquiring of the first content may include acquiring the first content from an external electronic device.

According to various embodiments, the designating of the second content may include: determining the correlation between the second content and the first content; designating the second content as the reference information when the correlation is a first designated degree; and undesignating the second content as the reference information when the correlation is a second designated degree.

According to various embodiments, the determining of the correlation may include determining whether the second content includes the same content as the first content.

According to various embodiments, the determining of the correlation may include determining whether the second content is simultaneously executed with the first content at least temporarily.

According to various embodiments, the determining of the correlation may include determining whether an activity designated for the second content has occurred.

According to various embodiments, the first content may be created or edited by first and second users, and the second content may include a plurality of pieces of content executed by each of the first and second users.

According to various embodiments, the second content may include a plurality of pieces of content, and the plurality of pieces of content may be executed through different electronic devices.

According to various embodiments, the method may further include updating the reference information on the basis of information on a user who wants to read the first content.

According to various embodiments, the updating of the reference information may include: identifying whether information corresponding to the user information exists among the reference information; and additionally searching for third content corresponding to the user information on the basis of the second content when there is no information corresponding to the user information.

According to various embodiments, the designating of the second content may include storing user activity information for the second content, a profile of a user corresponding to the electronic device, or external environment information for the electronic device.

According to various embodiments, the method may further include: displaying the second content through a display that is functionally connected to the electronic device; acquiring user information on the electronic device based on at least a part of the second content; and displaying an object, which corresponds to the user information, through the display in relation to the second content.

According to various embodiments, the method may further include: displaying the first content through a display that is functionally connected to the electronic device and displaying an object, which corresponds to the reference information, through the display in relation to the first content.

According to various embodiments, the method may further include identifying a user corresponding to the electronic device; determining at least one of a set and a format of the reference information corresponding to the user; and providing the reference information in relation to the first content on the basis of the at least one of the set and the format.

According to various embodiments, a method of managing reference information for provided content may include: identifying, in an electronic device, content provided through an external electronic device for the electronic device; determining at least some reference information to be provided in relation to the content among reference information executed in relation to the creation or editing of the subject content; and transmitting the at least some reference information to the external electronic device.

According to various embodiment, the identifying may include receiving a request for the at least some reference information from the external electronic device.

According to various embodiments, the determining may include: identifying a user for the external electronic device; and selecting information accessible by the user among the reference information as the at least some reference information.

According to various embodiments, the reference information may include a first set and a second set, and the determining may include: identifying a user for the external electronic device, selecting the first set as the at least some reference information when the user is a first user, and selecting the second set as the at least some reference information when the user is a second user.

According to various embodiments, the determining may include: identifying a user's profile for the external electronic device and determining a format to provide at least one of the at least some reference information and additional information for the at least some reference information on the basis of the profile.

According to various embodiments, the transmitting may include transmitting the additional information to the external electronic device to provide the additional information for the at least some reference information in relation to the subject content or the at least some reference information through the external electronic device.

According to various embodiments, the transmitting may include: creating another content including the content and the at least some reference information; and transmitting the other content to the external electronic device.

The electronic devices and the methods, according to the various embodiments, can designate (e.g., store) reference information, which is executed in relation to the creation or editing of content, in conjunction with the content, thereby improving inconvenience that a user has to separately mange the content and the reference information.

The electronic devices and the methods, according to the various embodiments, can provide content and reference information, which are associated with each other, to a reader, thereby solving inconvenience that the reader has to separately search for the reference information.

The electronic devices and the methods, according to the various embodiments, can provide content or reference information in various manners depending on readers, thereby helping provide suitable information to a user.

The embodiments of the present disclosure disclosed in the specification and the drawings are only particular examples provided in order to easily describe the technical matters of the present disclosure and to help with comprehension of the present disclosure, and are not intended to limit the scope of the present disclosure. In addition to the embodiments disclosed herein, the scope of the present disclosure should be construed to include all modifications or modified forms drawn based on the technical idea of the various embodiments of the present disclosure. Therefore, the scope of the present disclosure is defined not by the detailed description and embodiments, but by the following claims and their equivalents, and all differences within the scope will be construed as being in the present disclosure.

What is claimed is:

1. An electronic device comprising:
a display;
a memory configured to store reference information executed in relation to the creation or editing of a content; and
a processor configured to:
output the content through the display; and
output at least some of the reference information in relation to the content.

2. The electronic device of claim 1, wherein the reference information comprises at least a portion of another piece of content previously executed in relation to the content.

3. The electronic device of claim 1, wherein the reference information comprises another piece of content provided through at least one of a messenger, a message, a web editor, a browser, a document editor, a word processor, a spreadsheet, e-mail, a multimedia editor, a voice recorder, a camera, a telephone, a multimedia player, and a scheduler.

4. The electronic device of claim 1, wherein the processor is further configured to: identify a user of the electronic device, output a first set of the reference information as the at least some of the reference information when the user is a first user, and output a second set of the reference information as the at least some of the reference information when the user is a second user.

5. The electronic device of claim 1, wherein the processor is further configured to identify a profile for a user the electronic device, output a first set of the reference information as the at least some of the reference information when the profile is a first profile, and output a second set of the reference information as the at least some of the reference information when the profile is a second profile.

6. The electronic device of claim 5, wherein the profile comprises information on at least one of the user's interest, specialty, preference, and access authority for at least one of the content and the reference information.

7. The electronic device of claim 1, wherein the processor is further configured to identify a user of the electronic device, output the at least some of the reference information in a first format when the user is a first user, and output the at least some of the reference information in a second format when the user is a second user.

8. The electronic device of claim 1, wherein the processor is further configured to output additional information for the at least some of the reference information.

9. The electronic device of claim 8, wherein the at least some of the reference information comprises first reference information and second reference information, and the additional information comprises first additional information and second additional information, wherein the first additional information comprises emotional information of a first user corresponding to the first reference information, and the second additional information comprises emotional information of a second user corresponding to the second reference information.

10. The electronic device of claim 1, wherein the processor is further configured to provide additional information associated with the reference information in relation to the content and to select the at least some of the reference information, which corresponds to the additional information, from the reference information based on an input for the additional information.

11. A method in an electronic device comprising:
acquiring first content;
identifying second content executed in relation to the creation or editing of the first content; and
designating the second content as reference information for the first content.

12. The method of claim 11, wherein acquiring the first content comprises receiving the first content from an external electronic device.

13. The method of claim 11, wherein designating the second content comprises:
determining a correlation between the second content and the first content;
designating the second content as the reference information when the correlation is a first designated degree; and
undesignating the second content as the reference information when the correlation is a second designated degree.

14. The method of claim 13, wherein determining the correlation comprises determining whether the second content comprises a same content as the first content.

15. The method of claim 13, wherein determining the correlation comprises determining whether the second content is simultaneously executed with the first content at least temporarily.

16. The method of claim 13, wherein determining the correlation comprises determining whether an activity designated for the second content has occurred.

17. The method of claim 11, wherein the first content is created or edited by first and second users, and the second content comprises a plurality of contents executed by each of the first and second users.

18. The method of claim 11, further comprising:
updating the reference information on a basis of information on a user who wants to read the first content.

19. The method of claim 18, wherein updating the reference information comprises:
identifying whether information corresponding to the user information exists among the reference information; and
searching for third content corresponding to the user information based on the second content when there is no information corresponding to the user information.

20. The method of claim 11, wherein designating the second content comprises storing at least one of user activity information for the second content, a profile of a user corresponding to the electronic device, and external environment information for the electronic device.

21. The method of claim 11, further comprising:
displaying the second content through a display that is functionally connected to the electronic device;
acquiring user information on the electronic device based on at least a part of the second content; and
displaying an object, which corresponds to the user information, through the display in relation to the second content.

22. The method of claim 11, further comprising:
displaying the first content through a display that is functionally connected to the electronic device; and
displaying an object, which corresponds to the reference information, through the display in relation to the first content.

23. The method of claim 11, further comprising:
identifying a user corresponding to the electronic device;
determining at least one of a set and a format of the reference information corresponding to the user; and
providing the reference information related to the first content based on the at least one of the set and the format.

24. A method in an electronic device comprising:
identifying, by an electronic device, content provided through an external electronic device for the electronic device;
determining at least some reference information that is to be provided in relation to the content among reference information that is executed in regard to creating or editing subject content; and
transmitting the at least some reference information to the external electronic device.

25. The method of claim 24, wherein identifying comprises receiving a request for the at least some reference information from the external electronic device.

26. The method of claim 24, wherein determining comprises:
identifying a user for the external electronic device; and
selecting information that the user is to access among the reference information as the at least some reference information.

27. The method of claim 24, wherein the reference information comprises a first set and a second set, and
the determining comprises:
identifying a user for the external electronic device;
selecting the first set as the at least some reference information when the user is a first user; and
selecting the second set as the at least some reference information when the user is a second user.

28. The method of claim 24, wherein determining comprises:
identifying a user's profile for the external electronic device; and
determining a format for providing at least one of the at least some reference information or additional information for the at least some reference information based on the profile.

29. The method of claim 28, wherein the format comprises at least one of a color, a size, a shape, or graphics for at least one area of the at least some reference information.

30. The method of claim 24, wherein transmitting comprises transmitting additional information for the at least some reference information to the external electronic device such that the additional information is provided in relation to the subject content or the at least some reference information through the external electronic device.

31. The method of claim 24, wherein the transmitting comprises:
creating another piece of content that contains the content and the at least some reference information; and
transmitting the other piece of content to the external electronic device.
